(19) United States
(12) Patent Application Publication
(10) Pub. No.: US 2026/0070359 A1
(43) Pub. Date: Mar. 12, 2026

(54) PRINTING APPARATUS

(71) Applicant: CANON KABUSHIKI KAISHA, Tokyo (JP)

(72) Inventors: NORIKO SATO, Kanagawa (JP); YURI MORI, Tokyo (JP); SHOTA ASADA, Tokyo (JP); TETSUYO OHASHI, Kanagawa (JP); MINEYOSHI TOMIE, Saitama (JP); TAKESHI SEKINO, Kanagawa (JP); TAKASHI ABE, Kanagawa (JP); KOUSUKE TANAKA, Kanagawa (JP); TOSHIAKI TOKISAWA, Tokyo (JP); NORIO SAKURAI, Tokyo (JP)

(21) Appl. No.: 19/316,712

(22) Filed: Sep. 2, 2025

(30) Foreign Application Priority Data
Sep. 11, 2024 (JP) 2024-157737
Jun. 16, 2025 (JP) 2025-100378

(51) Int. Cl. B41J 29/13; B41J 2/175; B41J 13/10

(52) U.S. Cl. CPC B41J 29/13; B41J 2/1752; B41J 2/17553; B41J 13/103

(57) ABSTRACT

A printing apparatus includes a storage portion configured to store a container that stores a printing material to be applied to a print medium by a printing unit, a conveyance unit configured to convey the print medium along a conveyance path, and an opening/closing member configured to open/close an access path that enables access to the storage portion. The opening/closing member comprises a path forming member configured to form a partial section of the conveyance path crossing the access path in a state in which the access path is closed.

### BACKGROUND

### Field of the Technology

The present disclosure relates to a printing apparatus.

### Description of the Related Art

In a printing apparatus that performs printing by applying a printing material to a print medium, a printing material such as toner or ink is stored in a container and stored in a storage portion. If it is necessary to exchange the container or replenish the printing material, the work is performed by accessing the storage portion (for example, Japanese Patent No. 6977648).

The printing apparatus includes a conveyance path for conveying the print medium. In the conventional technique, the access path to the storage portion needs to be designed while avoiding the conveyance path, and there is a constraint in the degree of freedom of arrangement of the storage portion. As a result, for example, the printing apparatus is bulky, or increasing the printing material storage amount is impeded.

### SUMMARY

The present disclosure provides a technique for improving the degree of freedom of arrangement of a storage portion.

According to one aspect of the present disclosure, there is provided a printing apparatus comprising: a storage portion configured to store a container that stores a printing material to be applied to a print medium by a printing unit; a conveyance unit configured to convey the print medium along a conveyance path; and an opening/closing member configured to open/close an access path that enables access to the storage portion, wherein the opening/closing member comprises a path forming member configured to form a partial section of the conveyance path crossing the access path in a state in which the access path is closed.

Features of the present disclosure will become apparent from the following description of embodiments with reference to the attached drawings. The following description of embodiments are described by way of example.

### BRIEF DESCRIPTION OF THE DRAWINGS

FIG. 1 is a view showing the outer appearance of a printing apparatus according to an embodiment of the present disclosure; F

IG. 2 is a schematic view of the internal structure of the printing apparatus shown in FIG. 1;

FIG. 3 is a view showing an exchange mode of a container;

FIG. 4 is a block diagram showing the control circuit of the printing apparatus shown in FIG. 1;

FIG. 5 is a flowchart showing an example of processing executed by the control circuit shown in FIG. 4;

FIG. 6A is a front view of a printing apparatus according to another embodiment;

FIG. 6B is a sectional view taken along a line A-A in FIG. 6A;

FIG. 7A is a front view showing a mode in which an opening/closing member is detached in the example shown in FIG. 6A;

FIG. 7B is a sectional view taken along a line B-B in FIG. 7A;

FIG. 8 is a front view of a printing apparatus according to still another embodiment showing a mode in which an opening/closing member is detached;

FIG. 9 is a view showing an example of a configuration in which a container is placed on a tray and stored;

FIGS. 10A and 10B are views showing another example of the configuration of the opening/closing member;

FIG. 11 is a view showing still another example of the configuration of the opening/closing member;

FIGS. 12A and 12B are views showing yet another example of the configuration of the opening/closing member;

FIGS. 13A and 13B are views showing still another example of the configuration of the opening/closing member;

FIG. 14 is a view showing another example of the configuration of the storage portion;

FIG. 15 is a view showing an exchange mode of a container in the example shown in FIG. 14;

FIG. 16 is a flowchart showing an example of processing executed by the control circuit in the example shown in FIG. 14;

FIG. 17 is a view showing a printing material replenishing mode;

FIG. 18 is a schematic view of the internal structure of a printing apparatus according to another embodiment of the present disclosure;

FIG. 19 is a view showing the outer appearance of the printing apparatus according to another embodiment of the present disclosure;

FIG. 20 is a view showing the outer appearance of the printing apparatus shown in FIG. 19 to which a plurality of optional devices are attached;

FIG. 21 is a view showing a mode in which a storage cassette is detached in the printing apparatus shown in FIG. 19;

FIG. 22 is a view showing a mode in which a detachable unit is detached in the printing apparatus shown in FIG. 19;

FIG. 23 is a view showing a mode in which the opening/closing member is in an open state in the printing apparatus shown in FIG. 19;

FIG. 24 is a view showing a mode in which the opening/closing member is in an open state in the printing apparatus shown in FIG. 19;

FIG. 25 is a schematic view of the internal structures of the printing apparatus and the optional devices shown in FIG. 20;

FIG. 26 is a perspective view of a printing unit;

FIG. 27 is a sectional view taken along a line D-D in FIG. 26;

FIG. 28 is a view showing a state in which a cover and a feeding tray are extracted in the printing apparatus shown in FIG. 20;

FIG. 29 is a schematic view of the internal structure of the printing apparatus shown in FIG. 28;

FIG. 30 is a view showing the outer appearance of a printing apparatus 1A shown in FIG. 20 in which the opening/closing member is in the open state;

FIG. 31 is a plan view of the printing apparatus 1A shown in FIG. 20 in which the opening/closing member is in the open state;

FIG. 32 is an explanatory view of a regulating member;

FIG. 33 is an explanatory view of another regulating member;

FIGS. 34A and 34B are explanatory views of another regulating member; and

FIGS. 35A and 35B are explanatory views of another regulating member.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Outline of Printing Apparatus

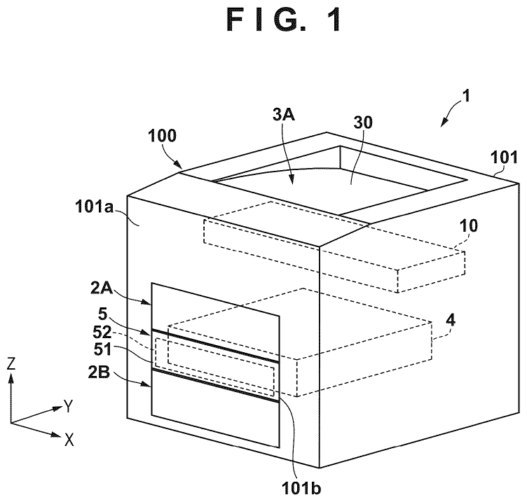

FIG. 1 is a view showing the outer appearance of a printing apparatus 1 according to an embodiment of the present disclosure. In this embodiment, a case where the present disclosure is applied to an inkjet printing apparatus configured to discharge ink as a printing material to a print medium to perform printing will be described. However, the printing material can also be applied to a printing apparatus of another type.

Note that “print” includes not only forming significant information such as characters and graphics but also forming images, figures, patterns, and the like on print media in a broad sense, or processing media, regardless of whether the information is significant or insignificant or whether the information is visualized so that a human can visually perceive it. In addition, although in this embodiment, sheet-like paper is assumed as a “print medium”, cloth, a plastic film, and the like may also be used.

In the drawings, arrows X, Y, and Z indicate directions crossing each other. The arrows X and Y indicate horizontal directions that are orthogonal to each other, and the arrow Z indicates the up/down direction. The X direction corresponds to the left/right direction (the lateral direction or the widthwise direction) of the printing apparatus 1, and the Y direction corresponds to the front/rear direction (the depth direction) of the printing apparatus 1. The Z direction corresponds to the height direction of the printing apparatus 1. Also, the downstream side and the upstream side are defined based on the conveyance direction of a print medium as a reference.

The printing apparatus 1 includes a main body 100, and storage cassettes 2A and 2B detachably attached to the main body 100. The main body 100 includes a housing 101 having a substantially rectangular parallelepiped shape, and the housing 101 forms the outer wall of the printing apparatus 1. Slots that allow the storage cassettes 2A and 2B storing print media to be detachably attached to the main body 100 are formed in a front surface 101a of the housing 101, which forms the front portion of the printing apparatus 1. The storage cassettes 2A and 2B are inserted/removed in the Y direction.

In the main body 100, a storage portion 4 is provided between the storage cassette 2A and the storage cassette 2B in the Z direction. The storage portion 4 forms a space to store a container that stores ink that is a printing material. An opening/closing member 5 that allows a user to access the storage portion 4 is provided on the front surface 101a of the housing 101.

A stacking portion 3A on which print media printed by a printing unit 10 in the main body 100 are stacked is provided on the upper surface of the main body 100. The stacking portion 3A includes a tray 30. A printed print medium is stacked on the tray 30.

FIG. 2 will be referred to in addition to FIG. 1. FIG. 2 is a schematic view of the internal structure of the printing apparatus 1. The printing apparatus 1 performs printing by the printing unit 10 on sheets SH that are print media before printing stacked on stacking portions 20 of the storage cassettes 2A and 2B. The stacking portions 20 are trays on which many sheets SH are stacked.

In this embodiment, the sheet SH before printing can be stacked on a stacking portion 2C as well. The stacking portion 2C includes a folding-type tray 222. FIG. 1 shows a mode in which the tray 222 is stored, and FIG. 2 shows a mode in which the tray 222 is extended. The tray 222 is used when, for example, a user manually supplies the sheet SH to the printing unit 10.

Also, in this embodiment, the printed sheet SH can be stacked on a stacking portion 3B as well. The stacking portion 3B includes a folding-type tray 31. FIG. 2 shows a mode in which the tray 31 is extended. The printing apparatus 1 discharges the printed sheet SH to the tray 30 or the tray 31.

In the main body 100, a conveyance path RT that guides conveyance of the sheet SH is formed. The conveyance path RT is a path that guides the sheet SH from the stacking portions 20 of the storage cassettes 2A and 2B or the stacking portion 2C to the tray 30 or the tray 31 via the printing unit 10. The conveyance path RT includes three start points P11 to P13 and two end points P21 and P22. In this embodiment, the conveyance path RT extends substantially horizontally on the front and rear sides of the printing unit 10 so as to divide the printing apparatus 1 into upper and lower sections. The conveyance path RT extends in a substantially S shape as a whole so as to cover the portion on the front side of the printing unit 10 and the portion on the rear side of the printing unit 10.

Sorting of the printed sheet SH to the stacking portion 3A or 3B can be performed by a flapper 9 arranged at the branch point of the conveyance path RT. The flapper 9 switches the conveyance destination of the sheet SH that has passed through the printing unit 10 to the stacking portion 3A or 3B. The flapper 9 is rotatably provided and rotated by an actuator such as an electromagnetic solenoid, thereby switching the path.

Note that the conveyance path RT is formed by a path forming member. As an example of the path forming member, FIG. 2 shows a path forming member 52 provided on the opening/closing member 5. The path forming member 52 includes path forming members 52a on the front and rear sides, which are apart in the Y direction. The path forming member 52 forms a partial section on the halfway of the conveyance path RT. More specifically, the path forming member 52 forms a section extending in the Z direction between an intermediate point P31 and an intermediate point P32. The conveyance path RT is defined by such path forming members.

A conveyance mechanism that conveys the sheet SH along the conveyance path RT will be described. The storage cassettes 2A and 2B each include a feeding unit (pickup roller) 21. The sheet SH on the stacking portion 20 is introduced into the conveyance path RT by the feeding unit 21. The feeding unit 21 rotates in a state in which it is in contact with the uppermost surface of the sheets SH stacked on the stacking portion 20 and thus starts feeding the sheet SH. The sheet SH is conveyed to a feeding unit 80.

In this embodiment, the storage portion 4 is arranged between the stacking portions 20 of the storage cassettes 2A and 2B in the Z direction, and the stacking portion 20 of the storage cassette 2A is arranged between the printing unit 10 and the storage portion 4. The stacking portion 20 of the storage cassette 2B is not arranged between the printing unit 10 and the storage portion 4 in the Z direction. The sheet SH conveyed from the stacking portion 20 of the storage cassette 2B passes through the path forming member 52, but the sheet SH conveyed from the stacking portion 20 of the storage cassette 2A does not pass through the path forming member 52.

The sheet on the stacking portion 2C is introduced into the conveyance path RT by a feeding unit (pickup roller) 223. The feeding unit 223 rotates in a state in which it is in contact with the sheet SH on the uppermost surface stacked on the stacking portion 2C and thus starts feeding the sheet SH. The sheet SH is conveyed to a conveyance unit 81.

The conveyance mechanism of the sheet SH further includes the feeding unit 80 and a plurality of conveyance units 81 to 84. In the conveyance direction of the sheet SH through the conveyance path RT, the feeding unit 80, the conveyance unit 81, the conveyance unit 82, the conveyance unit 83, and the conveyance unit 84 are arranged in this order from the upstream side to the downstream side. Note that in the following explanation, the leading edge and the trailing edge of the sheet SH mean the downstream end and the upstream end of the sheet SH, unless specified otherwise.

The feeding unit 80 conveys the sheet SH introduced into the conveyance path RT by the feeding unit 21 to the conveyance unit 81. The feeding unit 80 includes a feeding roller 80a and a driven roller 80b that is in pressure contact with the feeding roller 80a. The feeding roller 80a is a driving roller, and the driven roller 80b rotates following the rotation of the feeding roller 80a.

The sheet SH is clamped in the nip portion between the feeding roller 80a and the driven roller 80b, and conveyed by the rotation of the feeding roller 80a and the driven roller 80b. Note that the feeding unit 21 is a one-way roller, and after the sheet SH is conveyed to a position beyond the nip portion of the feeding unit 80, the conveyance can be continued by the feeding unit 80 even if the driving of the feeding unit 21 is stopped.

The conveyance unit 81 is arranged on the upstream side in the conveyance direction with respect to the printhead 11 provided in the printing unit 10, and the sheet SH is conveyed by the conveyance unit 81 to the downstream side between the printhead 11 and the platen 7 facing the printhead 11. The conveyance unit 81 includes a conveyance roller 81a and a driven roller (pinch roller) 81b that is brought into pressure contact with the conveyance roller 81a by a spring (not shown) or the like. The conveyance roller 81a is a driving roller, and the driven roller 81b rotates following the rotation of the conveyance roller 81a. The sheet SH is clamped in the nip portion between the conveyance roller 81a and the driven roller 81b, and conveyed by the rotation of the conveyance roller 81a and the driven roller 81b.

The conveyance unit 82 is arranged on the downstream side in the conveyance direction with respect to the printhead 11, and conveys the sheet SH conveyed by the conveyance unit 81 to the conveyance unit 83 on the downstream side. The conveyance unit 82 includes a conveyance roller 82a and a spur 82b that is brought into pressure contact with the conveyance roller 82a by a spring (not shown) or the like. The conveyance roller 82a is a driving roller, and the spur 82b rotates following the rotation of the conveyance roller 82a.

The conveyance unit 83 is a discharging unit that is arranged on the downstream side in the conveyance direction with respect to the printhead 11 and the conveyance unit 82 and discharges the sheet SH conveyed by the conveyance unit 82 to the tray 31 of the stacking portion 3B or the conveyance unit 84 in accordance with the position of the flapper 9. The conveyance unit 83 includes a conveyance roller 83a and a driven roller 83b that is brought into pressure contact with the conveyance roller 83a by a spring (not shown) or the like. The conveyance roller 83a is a driving roller, and the driven roller 83b rotates following the rotation of the conveyance roller 83a. The sheet SH is clamped in the nip portion between the conveyance roller 83a and the driven roller 83b, and conveyed by the rotation of the conveyance roller 83a and the driven roller 83b.

The conveyance unit 84 is a discharging unit that is arranged on the downstream side in the conveyance direction with respect to the conveyance unit 83 and discharges the sheet SH conveyed by the conveyance unit 83 to the tray 30 of the stacking portion 3A. The sheet SH discharged to the tray 30 is “face-down discharge” in which an image printed surface faces down. The conveyance unit 84 includes a conveyance roller 84a and a driven roller 84b that is brought into pressure contact with the conveyance roller 84a by a spring (not shown) or the like. The conveyance roller 84a is a driving roller, and the driven roller 84b rotates following the rotation of the conveyance roller 84a. The sheet SH is clamped in the nip portion between the conveyance roller 84a and the driven roller 84b, and conveyed by the rotation of the conveyance roller 84a and the driven roller 84b.

The printing unit 10 applies ink to the sheet SH, thereby printing an image. Ink application to the sheet SH is performed by discharging the ink from the printhead 11. The lower surface of the printhead 11 forms a discharge surface in which a plurality of nozzles for discharging ink are formed. The printhead 11 may be a full line type printhead. The printhead 11 may be a serial type printhead. If the printhead 11 is of the serial type, it is mounted on a carriage and moved in the main scanning direction (X direction) while discharging ink (print scanning). Intermittent conveyance of the sheet SH in the sub-scanning direction (Y direction) by the conveyance units 81 and 82 and print scanning are alternately performed, thereby printing an image on the sheet SH.

### Storage Structure and Access Structure of Container

Ink to be supplied to the printhead 11 is stored in a container 6. The ink is supplied from the container 6 to the printhead 11 via, for example, a tube. The container 6 is a hollow member having a rectangular parallelepiped shape as a whole and storing ink inside, and is a flat bottle-type container. The container 6 is stored in the storage portion 4. The storage portion 4 has an inlet 4a on the front side of the printing apparatus 1, and the container 6 can be inserted/removed into/from the inlet 4a in the Y direction. If the ink stored in the container 6 is consumed, the user can replenish the ink by exchanging the container 6 with a new one. In this case, the user needs to access the storage portion 4 (in other words, access the container 6).

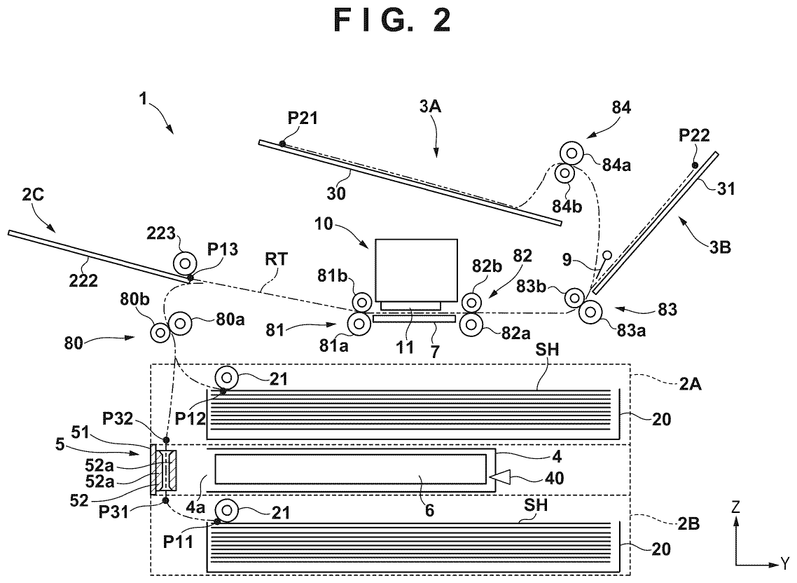

The opening/closing member 5 is a member that opens/closes an access path that enables access to the storage portion 4. FIG. 2 shows a case where the opening/closing member 5 is in a closed state, and FIG. 3 shows a case where the opening/closing member 5 is in an open state. In this embodiment, the opening/closing member 5 is detachably attached to the main body 100, and in attachment, positioned and locked to the main body 100 by an appropriate method. On the front surface 101a, an opening portion 101b is formed in the housing 101. As shown in FIG. 3, when the opening/closing member 5 is detached from the main body 100, the opening portion 101b is opened, and an access path AR is opened. The access path AR according to this embodiment is a space extending from the inlet 4a of the storage portion 4 to the front side of the printing apparatus 1 in the Y direction. In the open state of the access path AR shown in FIG. 3, the inlet 4a is exposed to the outside of the printing apparatus 1, and the user can access from the outside of the printing apparatus 1 to the storage portion 4. The user can exchange the container 6 in the storage portion 4. Whether the container 6 is attached to the storage portion 4 is detected by a sensor 40. The sensor 40 is, for example, an optical sensor or a wireless or wired reader that reads information in a memory provided on the container 6. When the opening/closing member 5 is attached to the main body 100, the inlet 4a (opening portion 101b) is covered with the opening/closing member 5, and the access path AR is closed by the opening/closing member 5.

The opening/closing member 5 includes a panel member 51 and the path forming member 52. The panel member 51 closes the opening portion 101b when closing the access path AR, and forms the outer wall, particularly, the front surface 101a of the printing apparatus 1 together with the housing 101. The path forming member 52 is fixed to the back surface of the panel member 51 and forms a partial section of the conveyance path RT extending in the Z direction between the intermediate point P31 and the intermediate point P32, as described above. The access path AR is a path traversing between the intermediate point P31 and the intermediate point P32 in the Y direction, and the section of the conveyance path RT between the intermediate point P31 and the intermediate point P32 crosses the access path AR.

As described above, in this embodiment, since the opening/closing member 5 forms a partial section of the conveyance path RT, a layout in which the access path AR crosses the partial section of the conveyance path RT can be employed. As compared to a layout in which the access path AR avoids the conveyance path RT, the degree of freedom of arrangement of the storage portion 4 can be improved. Particularly in recent years, there is a demand for a printing apparatus including a plurality of feeding units/discharging units capable of feeding/discharging enormous quantities of various print media, and the space occupied by the conveyance path of the print media in the printing apparatus is increasing. To increase the capacity of printing material storage portion in such a printing apparatus, the apparatus size may be large. According to this embodiment, it is possible to make the space for the storage portion 4 large while suppressing an increase of the apparatus size and also increase the capacity of the container 6.

Also, in this embodiment, the attaching/detaching operation of the storage cassettes 2A and 2B or the exchange operation of the container 6 can be performed from the side of the front surface 101a of the printing apparatus 1. It is possible to provide the printing apparatus 1 with excellent operability, for which a user operation is performed from one direction.

### Configuration of Control System

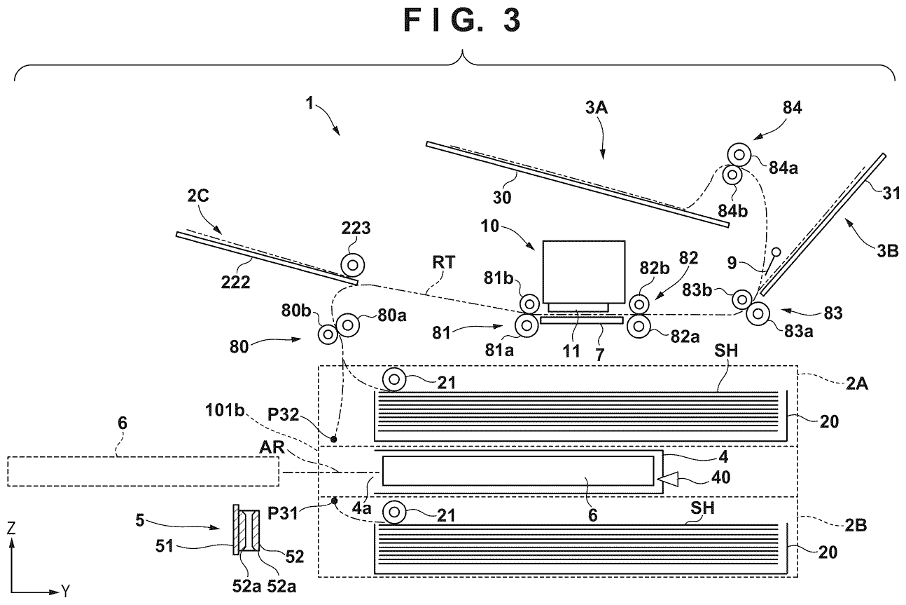

FIG. 4 is a block diagram of a control circuit 110 of the printing apparatus 1. The control circuit 110 includes at least one processor, and at least one storage device that stores programs to be executed by the processor. The storage device is, for example, a semiconductor memory. More specifically, the control circuit 110 includes a CPU 111 that controls the entire printing apparatus 1, and a RAM 112 and a ROM 113 which are configured to store various kinds of programs to be executed by the CPU 111 and various kinds of data. A timer 115 measures elapsed time.

The control circuit 110 also includes an external interface (I/F) 114 that receives a print instruction (print job) including print data from an external print server or an external PC, and a driver 116 that drives the printhead 11. Sensors 119 form a sensor group that detects the state of the printing apparatus 1, and include a sensor configured to detect the position of the sheet SH conveyed, the sensor 40, and the like. A driver 117 is a circuit that drives actuators 118, and the actuators 118 include motors that drive the driving rollers of a conveyance system of the sheet SH, and an actuator that drives the flapper 9.

### Stacking Portion Selection Processing

Sheets SH of different types or sizes can be stacked on the stacking portions 20 and the stacking portion 2C of the storage cassettes 2A and 2B. The printing apparatus 1 can select the sheet SH in accordance with a print job. Also, even in a case where, for example, the sheets SH of the same type are stacked on the stacking portions 20, the printing apparatus 1 can feed the sheet SH from the stacking portion 20 of higher priority order.

On the other hand, in this embodiment, during the work of exchanging the container 6, the conveyance path RT cannot be used in the section from the intermediate point P31 to the intermediate point P32 because of detachment of the opening/closing member 5. Hence, the sheet SH cannot be fed from the stacking portion 20 of the storage cassette 2B.

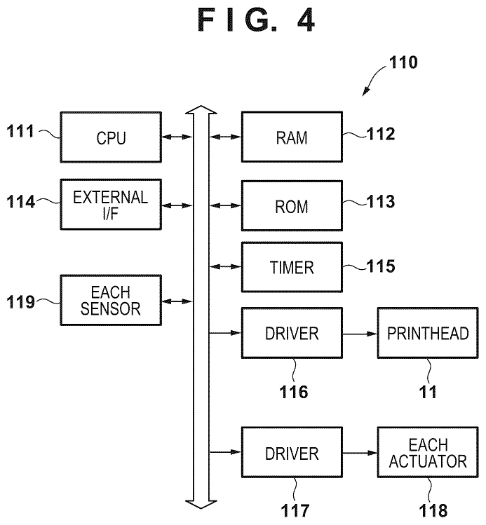

FIG. 5 is a flowchart showing an example of processing executed by the CPU 111 and showing an example of stacking portion selection processing that is performed when a print job is received. If a print job is received, in step S1, it is determined whether the stacking portion designated in the print job is the lower stacking portion (the stacking portion 20 of the storage cassette 2B). Upon determining that the stacking portion is the lower stacking portion, the process advances to step S2. Upon determining that the stacking portion is not the lower stacking portion, the feeding source of the sheet SH is determined to be the designated stacking portion (the stacking portion 20 of the storage cassette 2A or the stacking portion 2C), and the processing shown in FIG. 5 is ended.

In step S2, it is determined whether the user is accessing the storage portion 4. Here, the detection result of the sensor 40 is acquired, and if the detection result indicates that the container 6 does not exist in the storage portion 4, it is determined that the user is accessing the storage portion 4. Note that to determine whether the user is accessing the storage portion 4, a sensor configured to detect the open/closed state of the opening/closing member 5 may be provided, and if the detection result of the sensor indicates an open state, it may be determined that the user is accessing. Upon determining in step S2 that the user is accessing, the process advances to step S3. Upon determining that the user is not accessing, the feeding source of the sheet SH is determined to be the lower stacking portion, and the processing shown in FIG. 5 is ended.

In step S3, it is determined, based on the contents of the print job or the settings of the printing apparatus 1, whether change of the stacking portion is possible. If change is possible, the process advances to step S4. If change is not possible, the process advances to step S5. In step S4, the user or the printing apparatus 1 selects, a stacking portion (the stacking portion 20 of the storage cassette 2A or the stacking portion 2C) other than the lower stacking portion as the feeding source of the sheet SH, and determines the selection. An example in which the change is possible is a case where sheets SH of the same type as the sheets on the lower stacking portion are stacked on another stacking portion.

In step S5, based on the detection result of the sensor 40, the processing waits until the access of the user to the storage portion 4 is completed. At this time, a message indicating interruption may be displayed on a display device (not shown) provided on the printing apparatus 1, or an alarm sound may be output to promote completion of the access of the user. In addition, if it is confirmed, by time count of the timer 115, that the interruption time exceeds a predetermined time, the saving operation of the printing unit 10 (for example, an operation of covering the discharge surface of the printhead 11 by a cap (not shown)) may be performed.

As described above, according to this embodiment, even if the user is accessing the storage portion 4, it is determined whether the printing operation is possible or change of the stacking portion is possible. It is therefore possible to provide the convenient printing apparatus 1 capable of suppressing interruption of the printing operation.

### Second Embodiment

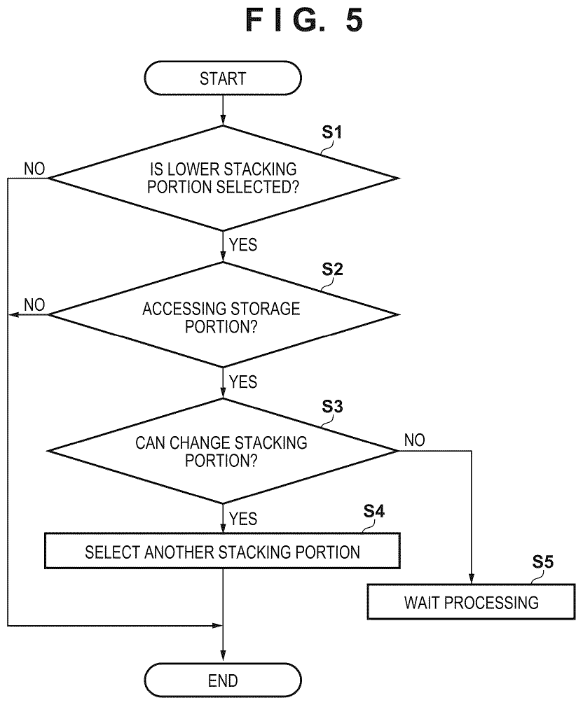

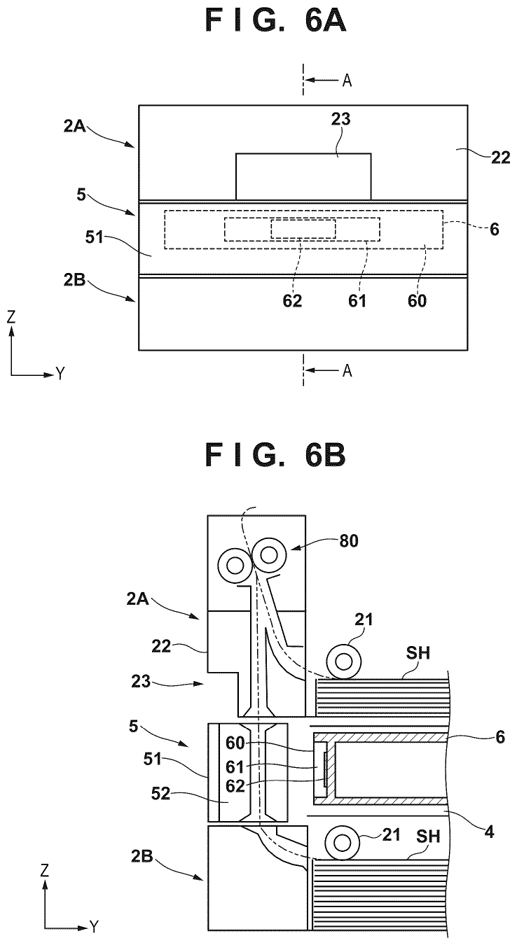

An operation portion used by a user to extract a container 6 from a storage portion 4 or a display portion that shows information about a printing material stored in the container 6 may be provided on the container 6. FIGS. 6A to 7B show an example. FIG. 6A is a front view of a printing apparatus 1, which is a view showing the periphery of the container 6 in a case where an opening/closing member 5 is in a closed state. FIG. 6B is a sectional view taken along a line A-A in FIG. 6A. FIG. 7A is a front view of the printing apparatus 1, which is a view showing the periphery of the container 6 in a case where the opening/closing member 5 is in an open state. FIG. 7B is a sectional view taken along a line B-B in FIG. 7A.

In this embodiment, an operation portion 61 and a display portion 62 are provided on a front surface 60 of the container 6. The operation portion 61 has a form of a concave portion having a depth in the Y direction. When the user puts a finger on the peripheral edge portion of the operation portion 61, he/she can easily grip the container 6. The operation portion 61 may have not the form of a concave portion but a form of a lever or a handle.

The display portion 62 has a form of a label adhered to the bottom portion of the operation portion 61 and has, for example, a portion of the same color as the color of ink stored in the container 6, thereby displaying the color of the ink. As shown in FIG. 7A, if the opening/closing member 5 is in the open state, the operation portion 61 and the display portion 62 are exposed to a front surface 101a of the printing apparatus 1, and the user can recognize these.

A concave portion 23 is provided around an opening portion 101b through which the container 6 is inserted/removed. In this embodiment, the concave portion 23 extended in the Y direction is formed on the upper side of the opening portion 101b. More specifically, the concave portion 23 having a notch shape opening downward is formed in a storage cassette 2A. In some cases, the printing apparatus 1 is installed at the position of the user's waist height. In this case, the user whose has opened the opening/closing member 5 looks down at the operation portion 61 and the display portion 62 or an inlet 4a, and the front surface 101a of a housing 101 may block the user's view. When the concave portion 23 is formed, as shown in FIG. 7B, the line-of-sight of the user readily reaches the operation portion 61 and the display portion 62 or the inlet 4a, and the user can easily recognize the presence of these. Also, when the concave portion 23 is formed, the user can easily insert a fingertip to the operation portion 61. Note that in this embodiment, the concave portion 23 also functions as a handle portion used by the user to place a hand when inserting/removing the storage cassette 2A.

The positional relationship between the concave portion 23 and the operation portion 61 and the display portion 62 will be described with reference to FIG. 7A. Concerning the position in the X direction, the concave portion 23 is extended within a range Rx1, the operation portion 61 is extended within a range Rx2, and the display portion 62 is extended within a range Rx3. In this embodiment, concerning the position in the X direction, the concave portion 23 is located at the same position as at least a part of the operation portion 61. More specifically, in this embodiment, the range Rx1 is included in the range Rx2. Hence, concerning the position in the X direction, the whole range of the concave portion 23 is included in the range of the operation portion 61. Also, in this embodiment, concerning the position in the X direction, the concave portion 23 is located at the same position as at least a part of the display portion 62. More specifically, in this embodiment, the range Rx1 includes the range Rx3. Hence, concerning the position in the X direction, the whole range of the display portion 62 is included in the range of the concave portion 23. Hence, the concave portion 23 can more reliably improve the visibility of the operation portion 61 and the display portion 62. Note that concerning the position in the X direction, if at least a part of the display portion 62 is located at the same position as the concave portion 23, the range Rx3 may be larger than the range Rx1.

Next, the positional relationship between the concave portion 23 and the inlet 4a of the storage portion 4 will be described with reference to FIG. 7A. A center line CL indicates the position of the center of the concave portion 23 in the X direction. A center line CL′ indicates the position of the center of the inlet 4a in the X direction. In this embodiment, the center lines CL and CL′ are both located at the center of the printing apparatus 1 in the X direction and match each other. Hence, concerning the position in the X direction, the concave portion 23 is located at the center portion of the inlet 4a. For this reason, the concave portion 23 can more reliably improve the visibility of the inlet 4a and, for example, the inlet 4a is easy to see when inserting the container 6 into the storage portion 4. Note that a configuration in which the center lines CL and CL′ do not match can also be employed.

### Third Embodiment

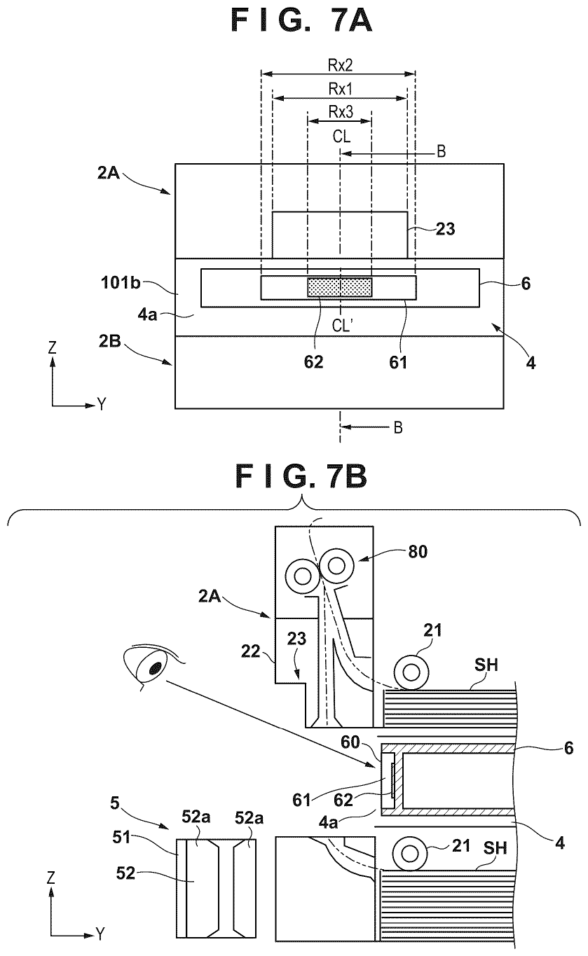

It is also possible to store a plurality of containers 6 in a storage portion 4. FIG. 8 is a front view of a printing apparatus 1 according to this embodiment, which is a view showing an inlet 4a of the storage portion 4 in a case where an opening/closing member 5 is in an open state. The storage portion 4 includes storage chambers 4A to 4D divided into two stages in the Z direction and into two columns in the X direction, and four containers 6A to 6D are stored in the storage chambers 4A to 4D.

Like the second embodiment, an operation portion 61 and a display portion 62 are provided for each container. The operation portion 61 and the display portion 62 are provided on a front surface 60 of each of the containers 6A to 6D. Concerning the position in the X direction, at least a part of each of the operation portion 61 and the display portion 62 is located in a range Rx1 of the concave portion 23. Hence, in this embodiment as well, the concave portion 23 can more reliably improve the visibility of the operation portion 61 and the display portion 62. Also, the display portions 62 of the containers 6A to 6D are located at the center portion of the inlet 4a. This arrangement allows the user to easily recognize the four display portions 62 at a glance.

### Fourth Embodiment

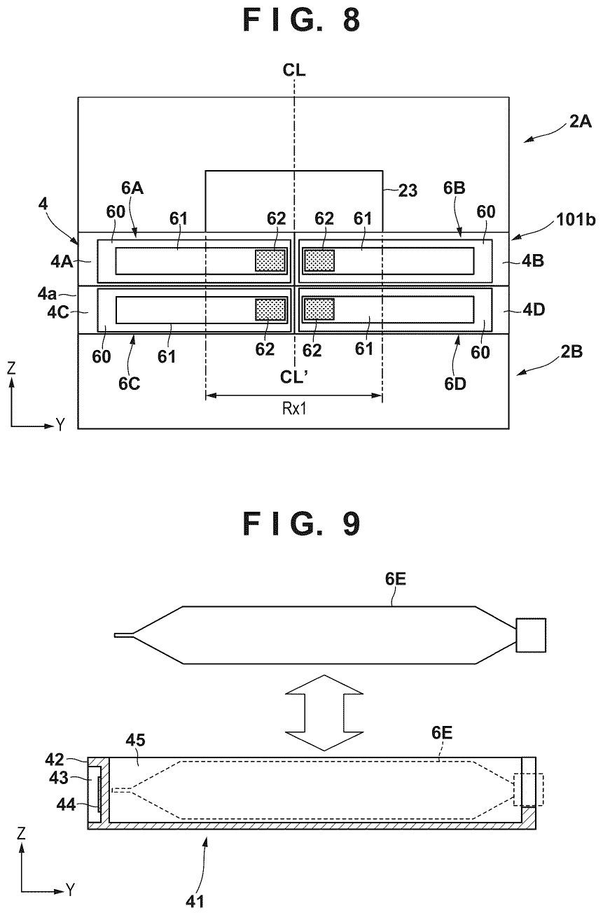

In the above-described embodiments, a bottle-type container has been exemplified as a container 6. In the above-described embodiments, the container 6 may be a bag-type container made of a flexible material. In this case, the container may be placed on a tray and stored in a storage portion 4. FIG. 9 shows an example. A container 6E is a bag-type ink pack and is placed on a tray 41 and stored in the storage portion 4. The tray 41 has a concave portion 45 opening upward on which the container 6E is placed. An operation portion 43 and a display portion 44, which correspond to the operation portion 61 and the display portion 62 in the second and third embodiments, are provided on a front surface 42 of the tray 41. This embodiment can be combined with the second and third embodiments. In this case, the positional relationship explained in the second and third embodiments can be applied as the positional relationship between the concave portion 23 or the inlet 4a and the operation portion 43 and the display portion 44.

### Fifth Embodiment

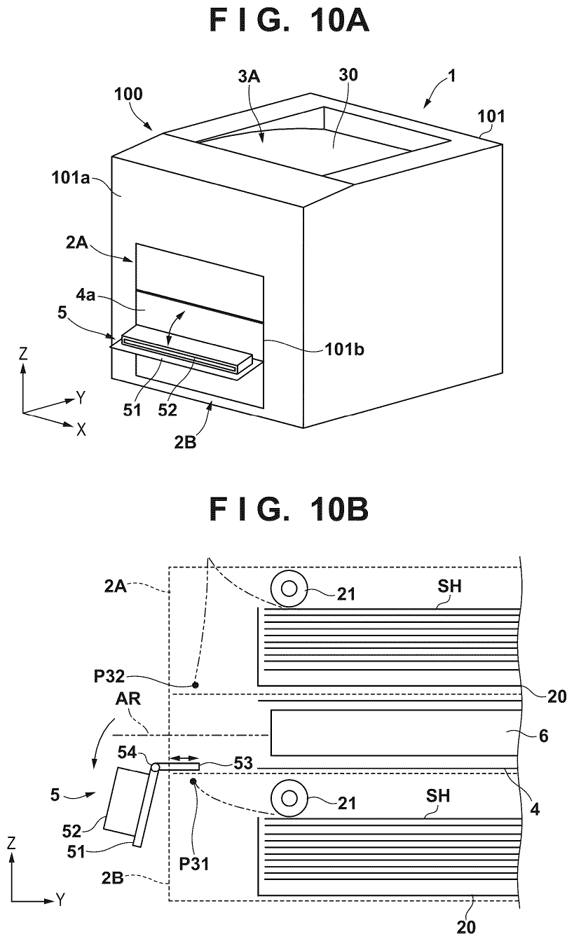

In the first embodiment, as the opening/closing form of the opening/closing member 5, attachment/detachment to/from the main body 100 has been exemplified. However, it may be rotation or translation. FIGS. 10A and 10B are views showing another example of the configuration of the opening/closing member 5. FIG. 10A is a view showing the outer appearance of a printing apparatus 1 in a case where the opening/closing member 5 is in an open state, and FIG. 10B is a sectional view showing the vicinity of an access path AR in the case where the opening/closing member 5 is in the open state.

In the example shown in FIGS. 10A and 10B, the opening/closing member 5 is rotatably supported by a slide member 53 via a shaft 54. The shaft 54 is a shaft in the X direction, and is located in the lower portion of the opening/closing member 5. The opening/closing member 5 rotates about a rotation center axis in the X direction. The slide member 53 is supported inside the main body 100 such that it can slide in the Y direction. To open the opening/closing member 5, it is extracted to the near side in the Y direction and rotated downward, thereby opening the access path AR. To close the opening/closing member 5, it is rotated upward and pushed to the far side in the Y direction, thereby closing the access path AR. Since the opening/closing member 5 is supported by the main body 100 regardless of whether it is open or closed, it is possible to prevent the opening/closing member 5 from being damaged in fall or lost. Note that the shaft 54 may be arranged in the upper portion of the opening/closing member 5, and the opening/closing member 5 may be rotated upward.

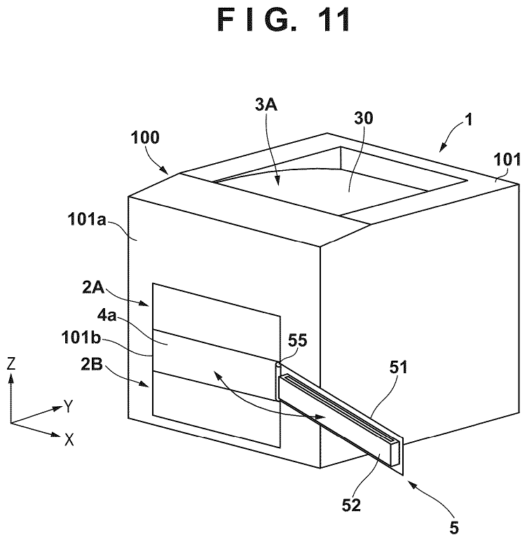

In the example shown in FIGS. 10A and 10B, an example in which the opening/closing member 5 rotates about the rotation center axis in the X direction has been described. However, the opening/closing member 5 may rotate about the rotation center axis in the Z direction. FIG. 11 shows an example. In the example shown in FIG. 11, the opening/closing member 5 is rotatably supported via a shaft 55 located at an end portion of the opening/closing member 5 in the X direction. The shaft 55 is a shaft in the Z direction, and the opening/closing member 5 rotates like a door about the rotation center axis in the Z direction.

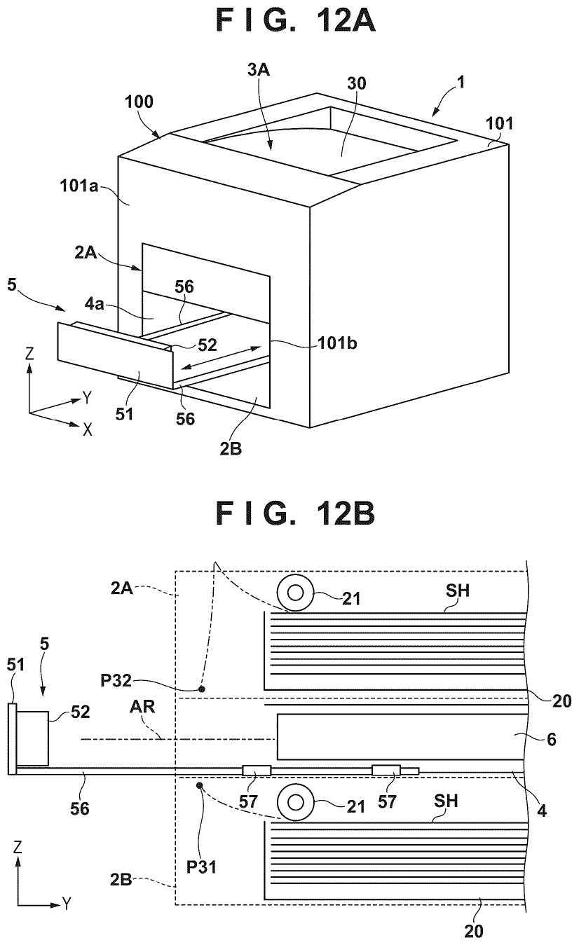

Next, FIGS. 12A and 12B show an example in which the opening/closing member 5 is opened/closed by translation. FIG. 12A is a view showing the outer appearance of the printing apparatus 1 in a case where the opening/closing member 5 is in an open state, and FIG. 12B is a sectional view showing the vicinity of the access path AR in the case where the opening/closing member 5 is in the open state.

A pair of left and right rail members 56 are connected to the opening/closing member 5. The rail members 56 are extended in the Y direction and supported by a plurality of guide members 57 provided in the main body 100 such that they can slide in the Y direction. To open the opening/closing member 5, it is extracted to the near side in the Y direction, thereby opening the access path AR. To close the opening/closing member 5, it is pushed to the far side in the Y direction, thereby closing the access path AR.

### Sixth Embodiment

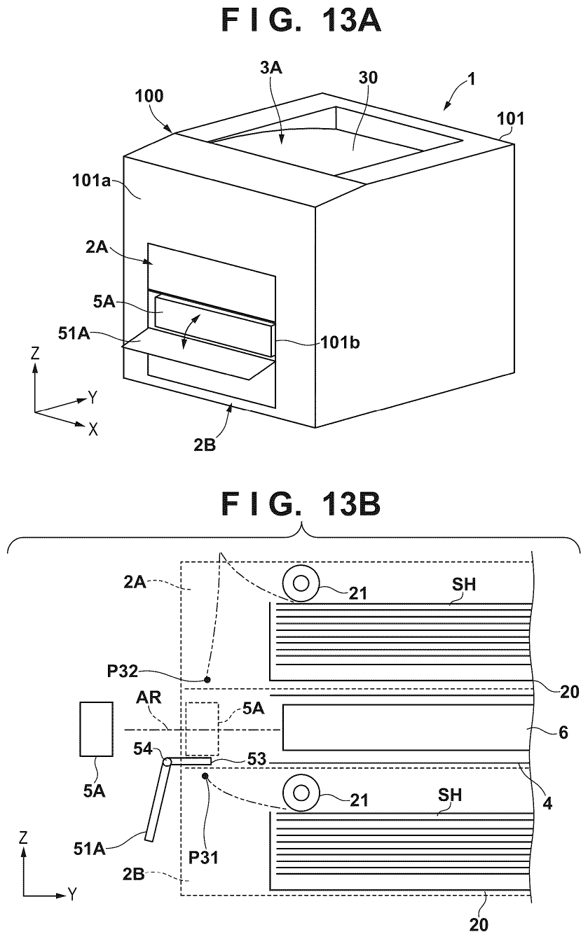

In the first embodiment, the opening/closing member 5 includes the panel member 51 and the path forming member 52. However, the opening/closing member may include not the panel member but only the path forming member. FIGS. 13A and 13B show an example. FIG. 13A is a view showing the outer appearance of the printing apparatus 1 according to this embodiment, and FIG. 13B is a sectional view showing the vicinity of the access path AR. In the example shown in FIGS. 13A and 13B, an opening/closing member 5A is a member separated from a panel member 51A corresponding to the panel member 51. The panel member 51A forms a part of a housing 101 and is rotatably provided, like the configuration example shown in FIGS. 10A and 10B. The opening/closing member 5A includes a portion corresponding to the path forming member 52 and forms a conveyance path RT between an intermediate point P31 and an intermediate point P32. When the panel member 51A is closed, the opening/closing member 5A is located inside (the rear side in the Y direction) the panel member 51A in the closed state.

FIG. 13A shows a state in which the panel member 51A is opened. In this state, an opening portion 101b is opened, but the access path AR is not opened because the opening/closing member 5A is attached to a main body 100. In this state, as shown in FIG. 13B, the opening/closing member 5A is further detached, thereby opening the access path AR. To close the access path AR, the opening/closing member 5A is attached to the main body 100. Then, the panel member 51A is closed. Thus, in this embodiment, opening/closing of the access path AR is performed in two steps.

### Seventh Embodiment

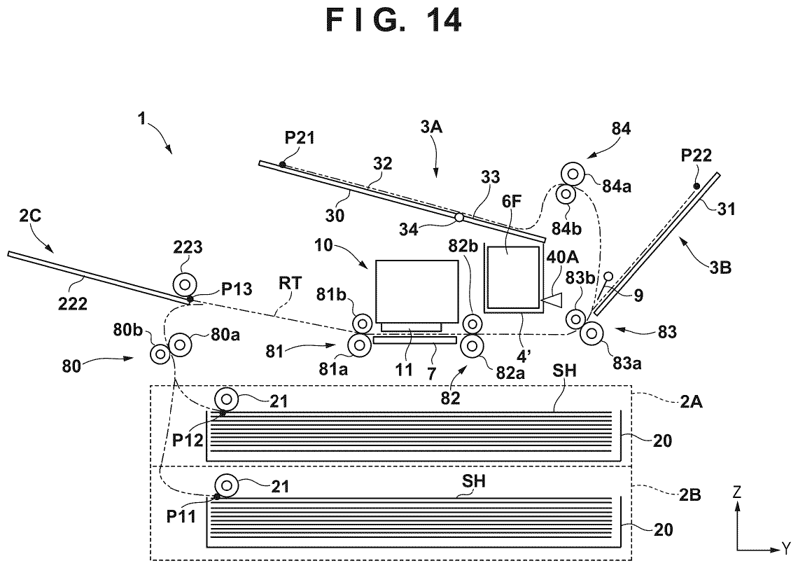

The position of a storage portion 4 or the part of an opening/closing member 5 can appropriately be designed. FIG. 14 is a schematic view of the internal structure of a printing apparatus 1 according to this embodiment. A structure different from the first embodiment will be described.

In the printing apparatus 1 according to this embodiment, in place of the storage portion 4, a storage portion 4′ is arranged on the lower side of a stacking portion 3A and on the upper side of storage cassettes 2A and 2B, and arranged on the rear side of a printing unit 10 in the Y direction. The storage cassettes 2A and 2B are arranged close in the up/down direction.

The storage portion 4′ opens upward, and a container 6F that stores ink as a printing material is stored in the storage portion 4′ such that it can be inserted/removed in the Z direction. The container 6F is a bottle-type container. Whether the container 6F is attached to the storage portion 4′ is detected by a sensor 40A. The sensor 40A is, for example, an optical sensor or a wireless reader that reads information in a memory provided on the container 6F.

A tray 30 of the stacking portion 3A includes a fixed portion 32 on the downstream side, and an opening/closing member 33 on the upstream side, which is rotatably provided on the fixed portion 32 via a hinge 34. In a closed state, the opening/closing member 33 forms a partial section of a conveyance path RT on the stacking portion 3A.

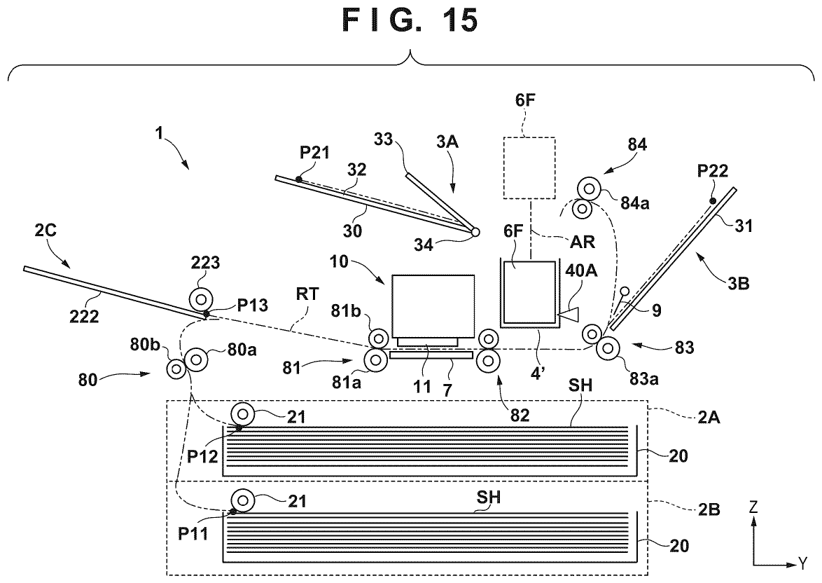

FIG. 15 shows a state in which the opening/closing member 33 is opened. An access path AR is opened, and the container 6F can be exchanged in the storage portion 4′.

Processing of selecting a stacking portion to discharge a printed sheet SH will be described next. In this embodiment, as the stacking portion of the discharge destination, the stacking portion 3A or a stacking portion 3B can be selected. On the other hand, in this embodiment, during the work of exchanging the container 6F, the sheet SH cannot be discharged to the stacking portion 3A because the opening/closing member 33 is open.

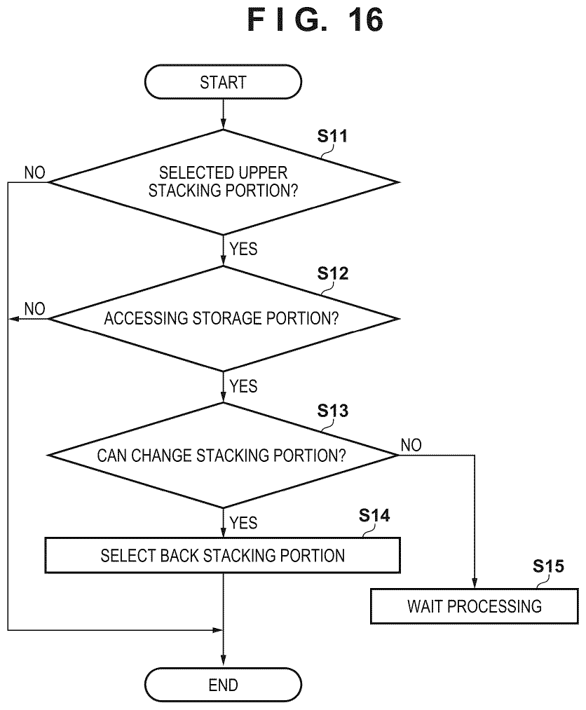

FIG. 16 is a flowchart showing an example of processing executed by a CPU 111 and showing an example of stacking portion selection processing that is performed when a print job is received. If a print job is received, in step S11, it is determined whether the stacking portion designated in the print job is the upper stacking portion (stacking portion 3A). Upon determining that the stacking portion is the upper stacking portion, the process advances to step S12. Upon determining that the stacking portion is not the upper stacking portion, the discharge destination of the sheet SH is determined to be the designated stacking portion (stacking portion 3B), and the processing shown in FIG. 16 is ended.

In step S12, it is determined whether the user is accessing the storage portion 4′. Here, the detection result of the sensor 40A is acquired, and if the detection result indicates that the container 6F does not exist in the storage portion 4′, it is determined that the user is accessing the storage portion 4′. Note that to determine whether the user is accessing the storage portion 4′, a sensor configured to detect the open/closed state of the opening/closing member 33 may be provided, and if the detection result of the sensor indicates an open state, it may be determined that the user is accessing. Upon determining in step S12 that the user is accessing, the process advances to step S13. Upon determining that the user is not accessing, the discharge destination of the sheet SH is determined to be the upper stacking portion (stacking portion 3A), and the processing shown in FIG. 16 is ended.

In step S13, it is determined, based on the contents of the print job or the settings of the printing apparatus 1, whether change of the stacking portion is possible. If change is possible, the process advances to step S14. If change is not possible, the process advances to step S15. In step S14, a back stacking portion (stacking portion 3B) that is a stacking portion other than the upper stacking portion is selected as the discharge destination of the sheet SH, and the selection is determined. An example in which the change is possible is a case where it can be confirmed that sheets SH of the same size can be discharged to the stacking portions 3A and 3B. In step S15, based on the detection result of the sensor 40A, the processing waits until the access of the user to the storage portion 4′ is completed.

According to this processing, even during access to the storage portion 4′, it is determined whether the printing operation is possible or change of the stacking portion of the discharge destination is possible. It is therefore possible to provide the convenient printing apparatus 1 capable to suppressing interruption of the printing operation.

Note that the printing apparatus 1 may include, further on the upper stage of the stacking portion 3A, a third or fourth stacking portion of the discharge destination having the same configuration as the stacking portion 3A. In this case, the conveyance path from the printing unit 10 to the third or fourth stacking portion crosses the access path AR, like the conveyance path RT from the printing unit 10 to the stacking portion 3A. That is, when performing discharge destination selection processing in FIG. 16, the third or fourth stacking portion can be handled like the stacking portion 3A.

### Eighth Embodiment

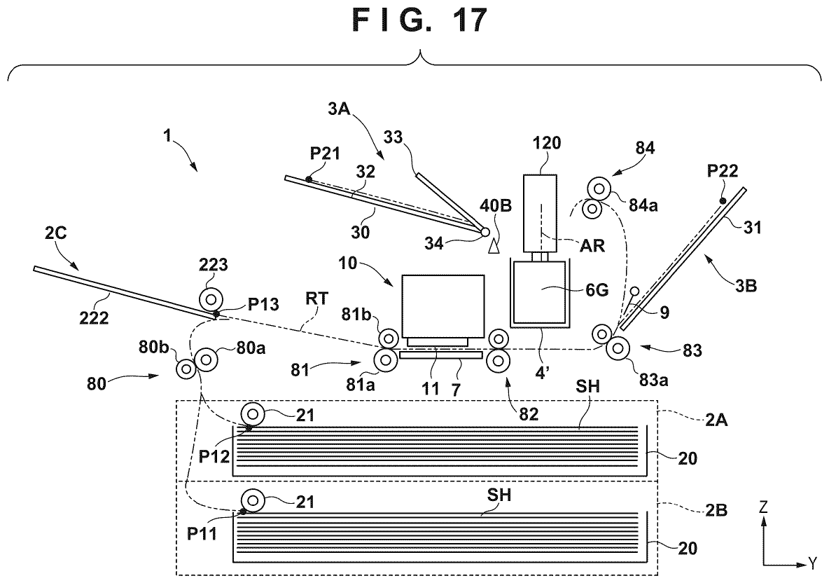

In the above-described embodiments, an example in which an access path AR is a container exchange path has bene described. However, the access path may be a printing material replenishing path. FIG. 17 shows an example, showing an example in which the access path AR is an ink replenishing path in the embodiment shown in FIG. 15. A container 6G is fixed to a storage portion 4′, and replenishment of ink is performed by connecting a replenishment bottle 120 to the container 6G. A sensor 40B is a sensor that detects the open/closed state of an opening/closing member 33. When the processing example shown in FIG. 16 is applied to this embodiment, in step S12, it is determined, based on the detection result of the sensor 40B, whether the user is accessing the storage portion 4′.

### Ninth Embodiment

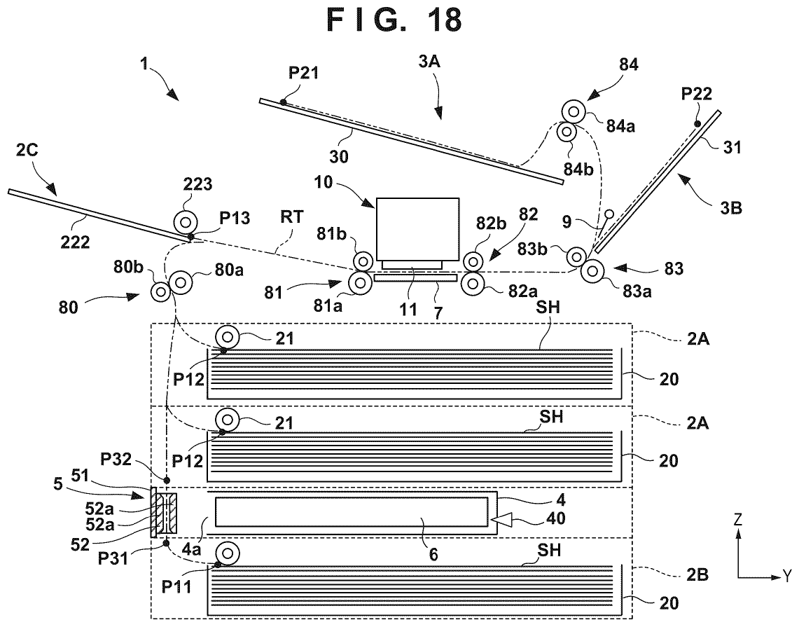

In the first embodiment, one stacking portion 20 (or one storage cassette 2A) is arranged between the printing unit 10 and the storage portion 4 in the Z direction. However, a plurality of stacking portions 20 (or a plurality of storage cassettes 2A) may be arranged. FIG. 18 shows an example. In the example shown in FIG. 18, two storage cassettes 2A are arranged between a printing unit 10 and a storage portion 4. Hence, two stacking portions 20 are arranged between the printing unit 10 and the storage portion 4. The storage amount of sheets SH can be increased, and or the types of sheets SH to be stored can be increased.

### 10th Embodiment

In the above-described embodiments, an inkjet printing apparatus that uses ink as a printing material has been exemplified as the printing apparatus 1. The printing method of the printing apparatus may be a so-called electrophotographic method, and the printing material may be toner.

### 11th Embodiment

### Outline of Printing Apparatus

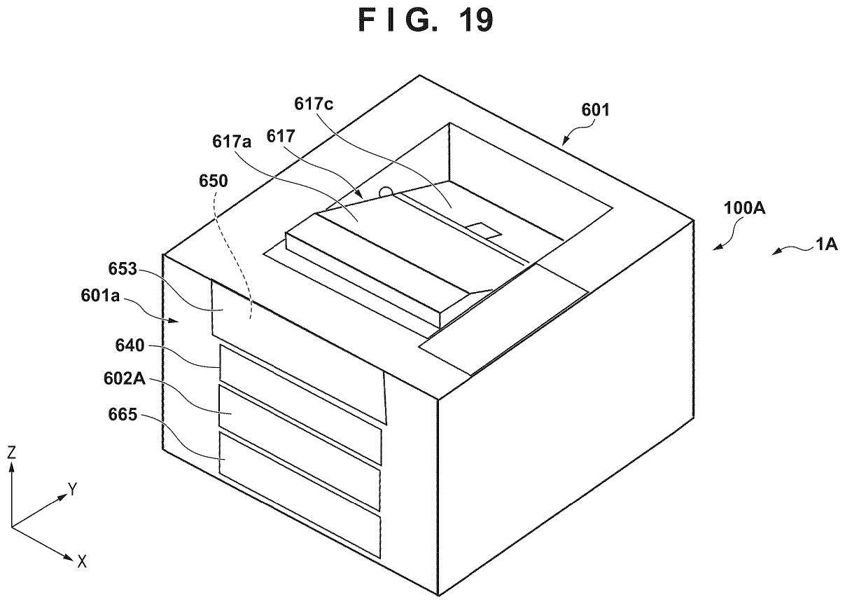

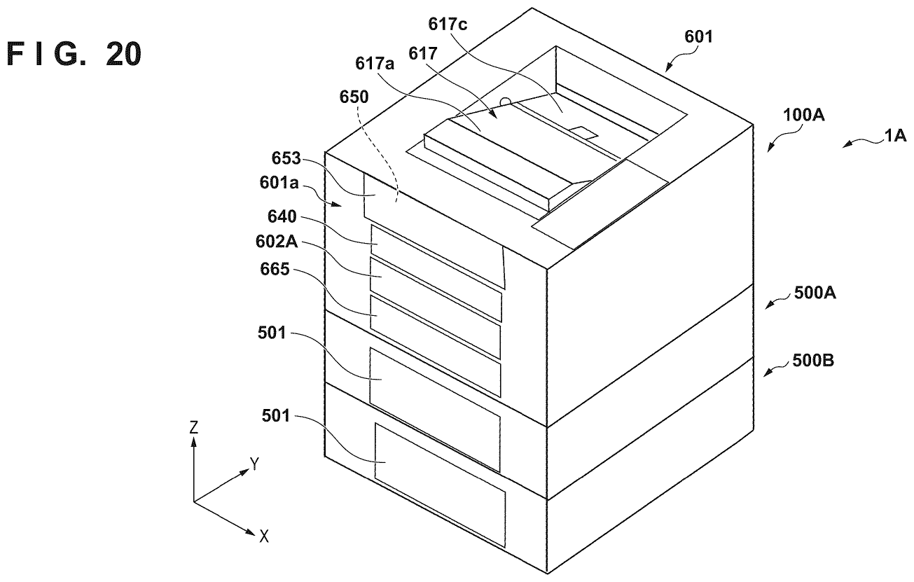

FIG. 19 is a view showing the outer appearance of a printing apparatus 1A according to the embodiment of the present disclosure. A plurality of optional devices can be attached to the printing apparatus 1A. FIG. 20 shows a mode in which optional devices 500A and 500B are attached to the printing apparatus 1A. The optional devices 500A and 500B are devices having the same configuration. When referring to the optional devices 500A and 500B collectively or without distinction, these will simply be referred to as optional devices 500. Each optional device 500 includes a storage cassette 501 that stores print media. By adding the optional devices 500, the storage amount of the print media to be used for printing or the types of print media to be used for printing can be increased. The storage cassette 501 is detachably attached to the main body of the optional device 500. In this embodiment, the storage cassette 501 is provided on the front surface of the optional device 500 such that it can be inserted/removed into/from the main body in the Y direction.

In the example shown in FIG. 20, two stages of optional devices 500 are provided under the printing apparatus 1A. However, only one optional device 500 can be attached to the printing apparatus 1A, or three or more stages of optional devices 500 can be attached to the printing apparatus 1A. In addition, the printing apparatus 1A can be used without attaching the optional device 500.

Note that in this embodiment, a case where the present disclosure is applied to a serial type inkjet printing apparatus will be described. However, the present disclosure can also be applied to a printing apparatus of another type.

In drawings to be explained in this embodiment, arrows X, Y, and Z indicate directions crossing each other. The arrows X and Y indicate horizontal directions that are orthogonal to each other, and the arrow Z indicates the up/down direction. The X direction corresponds to the left/right direction (the widthwise direction) of the printing apparatus 1A, and the Y direction corresponds to the front/rear direction (the depth direction) of the printing apparatus 1A. The Z direction corresponds to the height direction of the printing apparatus 1A. Also, the downstream side and the upstream side are defined based on the conveyance direction of a print medium as a reference.

The printing apparatus 1A includes a main body 100A, a detachable unit 640 detachable from the main body 100A, and a storage cassette 602A. The main body 100A includes a housing 601 having a substantially rectangular parallelepiped shape, and the housing 601 forms the outer wall of the printing apparatus 1A. The detachable unit 640 and the storage cassette 602A are attached to a front surface 601a of the housing 601, which forms the front portion of the printing apparatus 1A, such that these can be inserted/removed into/from the main body 100A in the Y direction. The front surface 601a is also provided with a cover 653 that can be opened/closed and cover a feeding unit 650 inside the main body 100A and an opening/closing member 665. The cover 653, the detachable unit 640, the storage cassette 602A, and the opening/closing member 665 are arranged in this order from above in the Z direction.

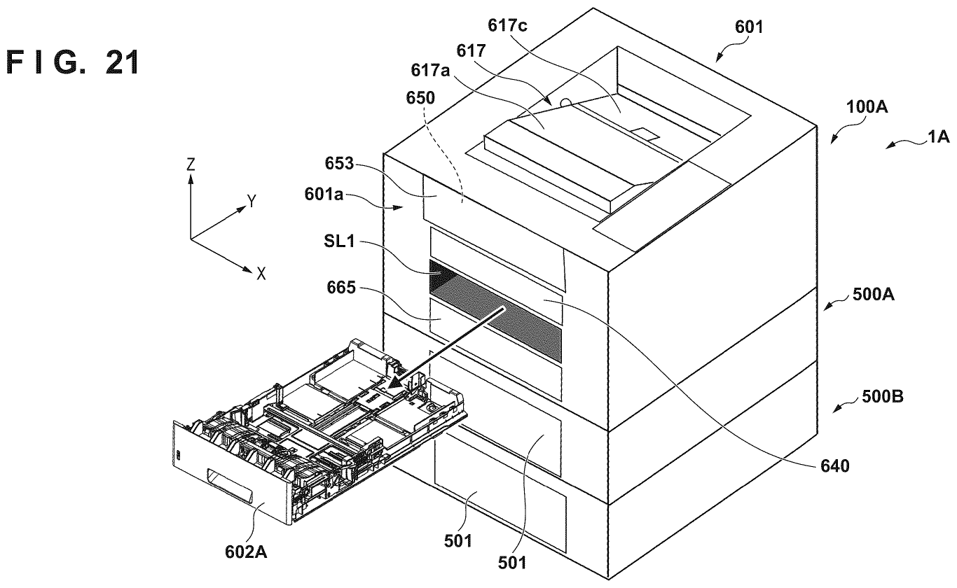

FIG. 21 shows a state in which the storage cassette 602A is extracted from the main body 100A in the −Y direction. The main body 100A has a slot SL1 that opens to the front surface 601a, and the storage cassette 602A is stored in the slot SL1.

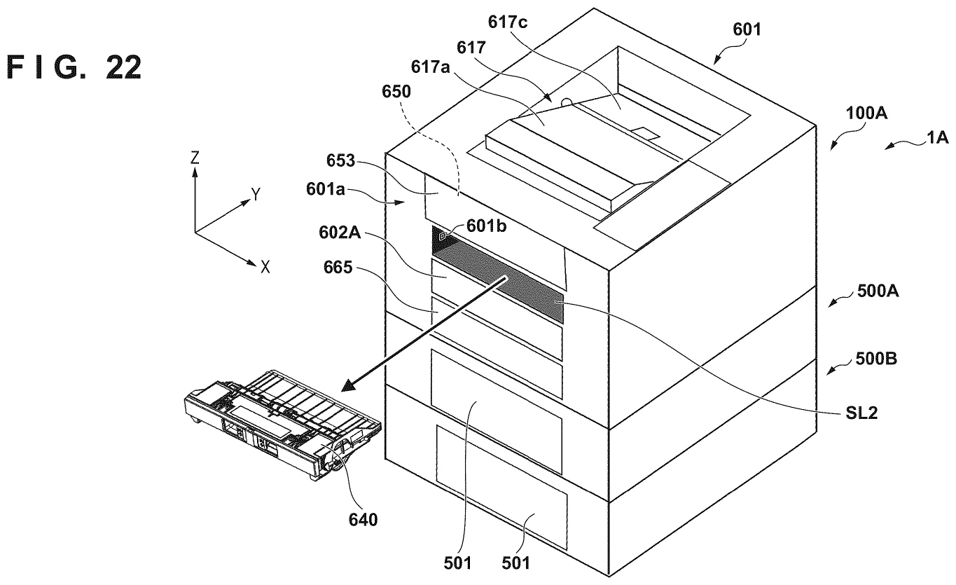

FIG. 22 is a view showing a state in which the detachable unit 640 is detached from the main body 100A in the −Y direction. The main body 100A has a slot SL2 opening to the front surface 601a, and the detachable unit 640 is stored in the slot SL2.

A discharge tray 617 is provided on the upper surface portion of the main body 100A. A printed print medium is discharged to the discharge tray 617 and stacked on the discharge tray 617.

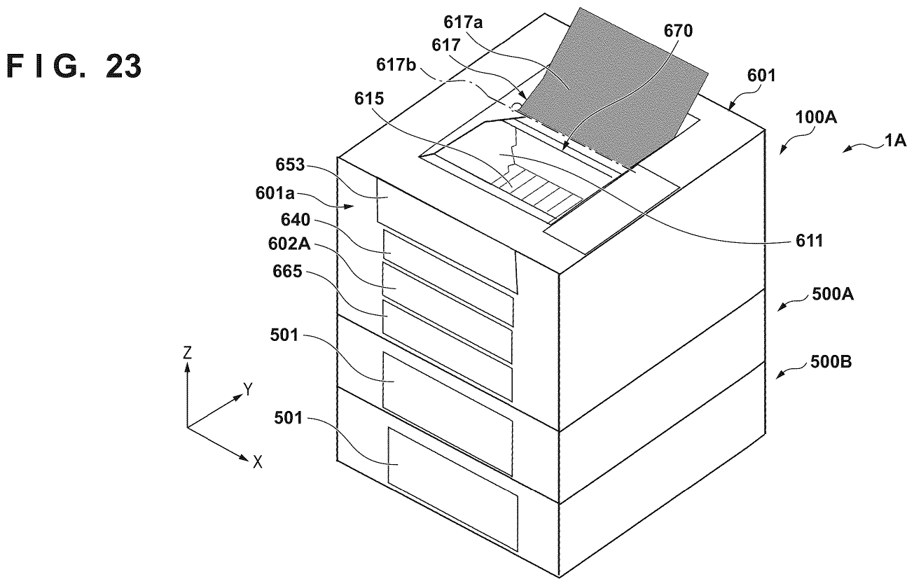

An opening portion 670 that is formed in the upper surface portion of the housing 601 and exposes the inside of the main body 100A of the printing apparatus 1A will be described with reference to FIGS. 20 and 23. The opening portion 670 is opened/closed by an opening/closing member 617a. In this embodiment, the opening/closing member 617a is a plate-shaped tray member that forms a part of the discharge tray 617, and is a rotation member provided to be rotatable about a rotation center axis 617b in the X direction. FIG. 23 shows a state in which the opening/closing member 617a is in an open state and the opening portion 670 is open. When the opening/closing member 617a is set in a closed state, as shown in FIG. 20, the opening portion 670 is closed.

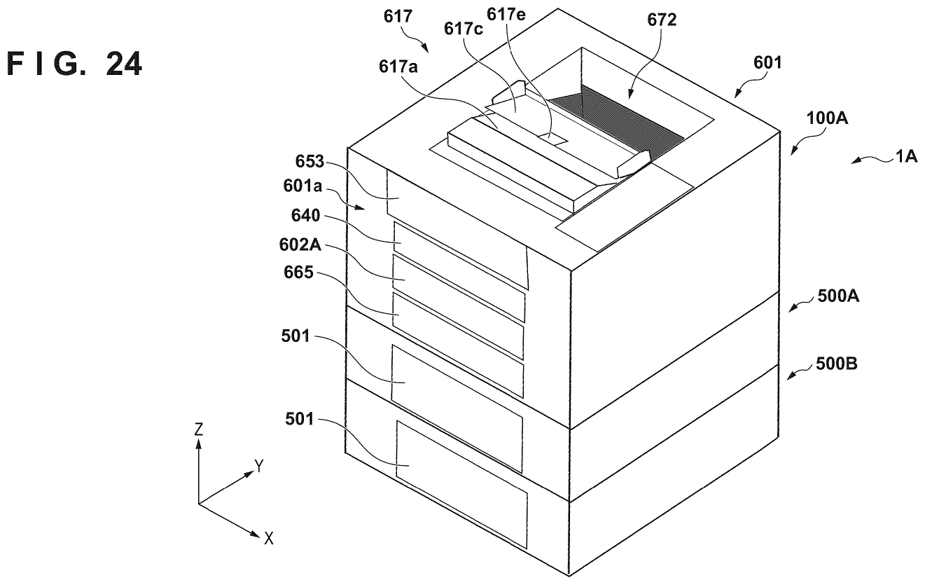

An opening portion 672 that is formed in the upper surface portion of the housing 601 and exposes the inside of the main body 100A of the printing apparatus 1A will be described with reference to FIGS. 20 and 24. The opening portion 672 is located on the far side in the Y direction with respect to the opening portion 670. The opening portion 672 is opened/closed by an opening/closing member 617c. In this embodiment, the opening/closing member 617c is a plate-shaped tray member that forms a part of the discharge tray 617 together with the opening/closing member 617a, and is extracted to the near side. When extracting the opening/closing member 617c, an operator can operate by holding a grip portion 617e. FIG. 24 shows a state in which the opening/closing member 617c is in an open state and the opening portion 672 is open. When the opening/closing member 617c is set in a closed state, as shown in FIG. 20, the opening portion 672 is closed.

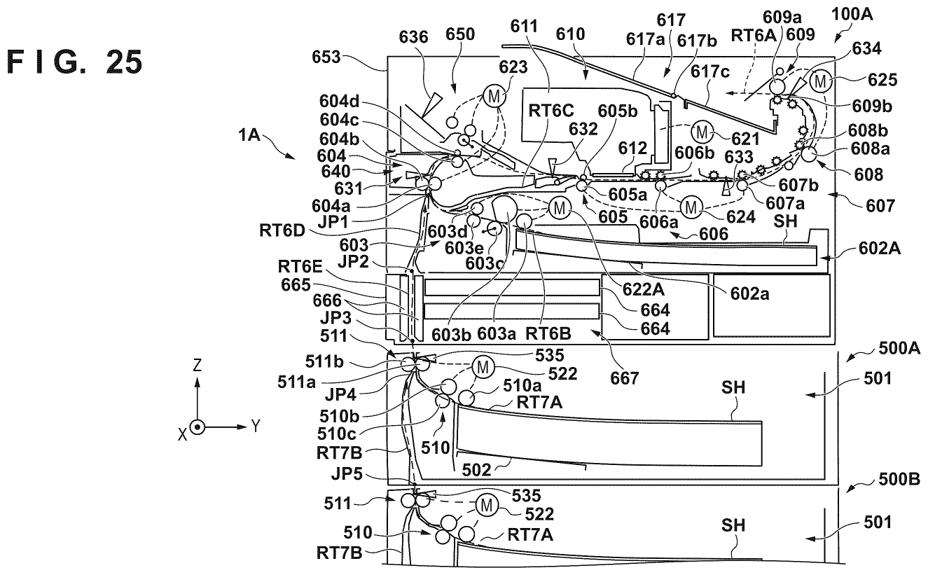

FIG. 25 is a schematic view of the internal structures of the printing apparatus 1A and the optional devices 500. The printing apparatus 1A performs printing on a sheet SH that is a print medium before printing stacked on a feeding tray 602a in the storage cassette 602A. In addition, the printing apparatus 1A discharges the printed sheet SH to the discharge tray 617. The storage cassette 602A can be detached from the main body 100A of the printing apparatus 1A, and the sheet SH can be set on the feeding tray 602a of the detached storage cassette 602A.

Also, the printing apparatus 1A performs printing on the sheet SH that is a print medium before printing stacked on a feeding tray 502 in each optional device 500. In addition, the printing apparatus 1A discharges the printed sheet SH to the discharge tray 617. A storage cassette 501 of each optional device 500 can be detached from the optional device 500, and the sheet SH can be set on the feeding tray 502 of the detached storage cassette 501.

### Conveyance Path

The conveyance path of the sheet SH will be described. The printing apparatus 1A includes conveyance paths RT6A to RT6E that guide the conveyance of the sheet SH. The conveyance path RT6A is a main conveyance path formed from a joining point JP1 to the discharge tray 617. The conveyance path RT6B is formed from the feeding tray 602a to the joining point JP1. When printing the sheet SH stored in the storage cassette 602A, the sheet SH is conveyed in the order of conveyance path RT6B→conveyance path RT6A, and printing is performed in the process of conveyance.

The conveyance paths RT6D and RT6E are conveyance paths configured to feed the sheet SH from the optional device 500. The conveyance path RT6D is formed in the Z direction at the front portion of the storage cassette 602A. When the storage cassette 602A is attached to the main body 100A, the conveyance path RT6D is formed from an intermediate point JP2 to the joining point JP1. The conveyance path RT6E is formed in the Z direction at the front portion of the opening/closing member 665. When the opening/closing member 665 is attached to the main body 100A, the conveyance path RT6E is formed from an intermediate point JP3 to the intermediate point JP2.

Each optional device 500 includes conveyance paths RT7A and RT7B that guide the conveyance of the sheet SH. The conveyance path RT7A is a conveyance path formed from the feeding tray 502 to a joining point JP4 in the storage cassette 501 and configured to feed the sheet SH in the optional device 500. The conveyance path RT7B is formed at the front portion of the storage cassette 501 from an intermediate point JP5 to the joining point JP4. The conveyance path RT7B is a conveyance path configured to pass the sheet SH fed from another optional device 500 located on the lower side of the optional device 500. For example, in the example shown in FIG. 25, the conveyance path RT7B of the optional device 500A is a path configured to pass, through the optional device 500A, the sheet SH fed from the optional device 500B.

When printing the sheet SH stored in the optional device 500A, the sheet SH is conveyed in the order of conveyance path RT7A of optional device 500A→conveyance path RT6E of printing apparatus 1A→conveyance path RT6D→conveyance path RT6A, and printing is performed in the process of conveyance.

When printing the sheet SH stored in the optional device 500B, the sheet SH is conveyed in the order of conveyance path RT7A of optional device 500B→conveyance path RT7B of optional device 500A→conveyance path RT6E of printing apparatus 1A→conveyance path RT6D→conveyance path RT6A, and printing is performed in the process of conveyance.

A path configured to invert the sheet SH and convey it to a printhead 612 for double-sided printing will be described next. In this embodiment, after the first surface of the sheet SH is printed by the printhead 612, the sheet SH is conveyed to the conveyance path RT6C, thereby inverting the sheet SH. The conveyance path RT6C is a sub conveyance path formed from the vicinity of a conveyance unit 605 to be described later to the joining point JP1. It is possible to invert the sheet SH with the printed first surface via the conveyance path RT6C and introduce it into the conveyance path RT6A. Then, printing can be performed for the second surface of the sheet SH.

Introduction of the sheet SH into the conveyance path RT6C is performed in the following way. After the trailing edge of the sheet SH reaches the vicinity of the conveyance unit 605 to be described later or exits from the conveyance unit 605, the rollers of at least some of the conveyance units 605 to 609 to be described later are rotated reversely. The sheet SH with the printed first surface can thus be introduced into the conveyance path RT6C. The sheet SH with the printed second surface is discharged to the discharge tray 617.

Note that each conveyance path is formed by path forming members. As an example of the path forming members, FIG. 25 schematically shows a pair of path forming members 666 that form the conveyance path RT6E. The pair of path forming members 666 are arranged to face each other in the Y direction, and the conveyance path RT6E extending in the Z direction is formed between these. Each conveyance path is defined by such path forming members.

### Conveyance Mechanism

A configuration for conveying the sheet SH will be described next. The printing apparatus 1A includes a feeding unit 603, a feeding unit 604, and the plurality of conveyance units 605 to 609. The feeding unit 603, the feeding unit 604, and the conveyance units 605 to 609 are arranged in this order from the upstream side to the downstream side in the conveyance direction of the sheet SH in the conveyance path RT6B and the conveyance path RT6A. Image formation (printing) for the sheet SH is performed by a printing unit 610 between the conveyance unit 605 and the conveyance unit 606.

### Feeding Unit 603

The sheet SH on the feeding tray 602a is introduced into the conveyance path RT6B and the conveyance path RT6A one by one by the feeding unit 603. The feeding unit 603 is a pickup mechanism that picks up the sheet SH from the feeding tray 602a using a feeding motor 622A as a driving source. The feeding unit 603 includes a feeding roller (pickup roller) 603a, a feeding roller 603b, a separation roller 603c, a feeding roller 603d, and a driven roller 603e that forms a nip with the feeding roller 603d.

The feeding roller 603a contacts the uppermost surface of the sheet SH stacked on the feeding tray 602a and is rotated by the driving force of the feeding motor 622A, thereby starting feeding the sheet SH. The feeding roller 603b that is rotated by the driving force of the feeding motor 622A and the separation roller 603c that forms a nip portion with the feeding roller 603b are arranged on the downstream side of the feeding roller 603a. The separation roller 603c is a roller that includes a torque limiter and has a rotational resistance. If two or more sheets SH enter the nip portion between the feeding roller 603b and the separation roller 603c, the sheet SH is separated one by one by the rotational resistance of the separation roller 603c.

The separated sheet SH is conveyed to the feeding roller 603d and the driven roller 603e on the downstream side. The feeding roller 603d uses the feeding motor 622A as the driving source.

### Feeding Unit 604

The feeding unit 604 conveys the sheet SH introduced from the joining point JP1 into the conveyance path RT6A to the conveyance unit 605. The feeding unit 604 includes feeding rollers 604a and 604c. The feeding rollers 604a and 604c are rotors that are rotated by the driving force of a feeding motor 623. The feeding rollers 604a and 604c are in pressure contact with corresponding driven rollers 604b and 604d to form nip portions. The driven rollers 604b and 604d are rotors following the rotation of the feeding rollers 604a and 604c.

The sheet SH is clamped in the nip portion between the feeding roller 604a and the driven roller 604b and the nip portion between the feeding roller 604c and the driven roller 604d and conveyed by the rotation of these.

Note that the feeding rollers 603a, 603b, and 603d are one-way rollers. For this reason, after the leading edge of the sheet SH is conveyed to a position beyond the nip portion of the feeding unit 604, the conveyance can be continued by the feeding unit 604 even if the driving of the feeding unit 603 is stopped.

The sensor 631 is a sensor that detects the sheet SH, and is a sensor that detects passage of the leading edge and the trailing edge of the sheet SH. The detection position of the sensor 631 is set to a position on the downstream side of the nip portion of the feeding roller 604a. After passage of the leading edge of the sheet SH is detected, the detection result of the sensor 631 can be used as a trigger for conveyance control to, for example, stop driving of the feeding unit 603 or increase the conveyance speed of the feeding unit 604.

Also, using the sensor 631, the size of the sheet SH can be detected based on the driving amounts of the motor 623 and a motor 624 from detection of the leading edge of the sheet SH to detection of the trailing edge, and subsequent conveyance control can be switched.

### Conveyance Unit 605

The conveyance unit 605 is arranged on the upstream side of the printhead 612. The conveyance unit 605 conveys the sheet SH to the downstream side between the printhead 612 and a platen 615 facing the printhead 612. The conveyance unit 605 includes a conveyance roller 605a, and a driven roller (pinch roller) 605b brought into pressure contact with the conveyance roller 605a by a spring (not shown) or the like. The conveyance roller 605a is a rotor that is rotated by the driving force of the conveyance motor 624, and the driven roller 605b is a rotor that rotates following the rotation of the conveyance roller 605a. The sheet SH is clamped in the nip portion between the conveyance roller 605a and the driven roller 605b, and conveyed by the rotation of the conveyance roller 605a and the driven roller 605b.

A sensor 632 is a sensor that detects the sheet SH, and is a sensor that detects passage of the leading edge and the trailing edge of the sheet SH, like the sensor 631. The sensor 632 is, for example, an optical sensor. Since the sensor 632 is arranged on the upstream side near the conveyance unit 605, the detection result can be used to manage the loop amount of registration of the sheet SH or the positions of the leading edge and the trailing edge of the sheet SH.

### Conveyance Unit 606

The conveyance unit 606 is arranged on the downstream side of the printhead 612 and conveys the sheet SH conveyed by the conveyance unit 605 up to the conveyance unit 609 on the downstream side. The conveyance unit 606 includes a conveyance roller 606a, and a spur 606b that is brought into pressure contact with the conveyance roller 606a by a spring (not shown) or the like. The conveyance roller 606a is a rotor that is rotated by the driving force of the conveyance motor 624, and the spur 606b is a rotor that rotates following the rotation of the conveyance roller 606a. In this embodiment, the conveyance unit 605 and the conveyance unit 606 share the driving source (conveyance motor 624).

### Conveyance Unit 607

The conveyance unit 607 is arranged on the downstream side of the printhead 612 and the conveyance unit 606 and conveys the sheet SH conveyed by the conveyance unit 606 to the downstream side. The conveyance unit 607 includes a conveyance roller 607a, and a spur 607b that is brought into pressure contact with the conveyance roller 607a by a spring (not shown) or the like. The conveyance roller 607a is a rotor that is rotated by the driving force of the conveyance motor 624, and the spur 607b is a rotor that rotates following the rotation of the conveyance roller 607a. The sheet SH is clamped in the nip portion between the conveyance roller 607a and the spur 607b and conveyed by the rotation of the conveyance roller 607a and the spur 607b.

A sensor 633 is, for example, an optical sensor and detects the sheet SH, like the sensors 631 and 632. The sensor 633 can be used to detect the leading edge and the trailing edge of the sheet SH or detect the presence/absence of the sheet SH in the conveyance path if a jam of the sheet SH occurs in the conveyance path.

### Conveyance Units 608 and 609

The conveyance units 608 and 609 are arranged on the downstream side of the printhead 612 and the conveyance units 606 and 607. The conveyance units 608 and 609 are discharging units that discharge the sheet SH conveyed by the conveyance unit 607 to the discharge tray 617. In single-sided printing, the sheet SH discharged to the discharge tray 617 is so-called “face-down discharge” in which an image printed surface faces down. In double-sided printing, the second surface faces down.

The conveyance unit 608 includes a conveyance roller 608a, and a spur 608b that is brought into pressure contact with the conveyance roller 608a by a spring (not shown) or the like. The conveyance roller 608a is a rotor that is rotated by the driving force of a conveyance motor 625, and the spur 608b is a rotor that rotates following the rotation of the conveyance roller 608a. The sheet SH is clamped in the nip portion between the conveyance roller 608a and the spur 608b and conveyed by the rotation of the conveyance roller 608a and the spur 608b.

The conveyance unit 609 includes a conveyance roller 609a, and a spur 609b that is brought into pressure contact with the conveyance roller 609a by a spring (not shown) or the like. The conveyance roller 609a is a rotor that is rotated by the driving force of the same conveyance motor 625 as that for the conveyance unit 608, and the spur 609b is a rotor that rotates following the rotation of the conveyance roller 609a. The sheet SH is clamped in the nip portion between the conveyance roller 609a and the spur 609b and conveyed by the rotation of the conveyance roller 609a and the spur 609b.

In this embodiment, the conveyance unit 608 and the conveyance unit 609 share the driving source (conveyance motor 625). However, the conveyance motor 625 may be eliminated, and the conveyance motor 624 that is the driving source for the conveyance units 605 to 607 may be shared by the conveyance unit 608 and the conveyance unit 609 as well.

Also, in this embodiment, four conveyance units (conveyance units 606 to 609) are used on the downstream side of the printhead 612. However, the number of conveyance units may be decreased in accordance with the conveyance-direction size of the corresponding print medium of the printing apparatus 1A. For example, only the conveyance unit 606 and the conveyance unit 609 may be left, and the conveyance unit 609 may discharge the sheet SH to the discharge tray 617.

A sensor 634 is a sensor that detects the sheet SH, and is a sensor that detects passage of the leading edge and the trailing edge of the sheet SH, like the sensors 631 to 633. The sensor 634 is, for example, an optical sensor. In this embodiment, after the trailing edge of the sheet SH is detected by the sensor 634, discharge is completed (the trailing edge of the sheet SH reaches the discharge tray 617) after a predetermined conveyance amount. Hence, the detection result of the sensor 634 can be used to detect discharge of the sheet SH.

The conveyance mechanism of the sheet SH provided in the optional device 500 will be described next. The sheet SH set on the feeding tray 502 is separated one by one by a feeding unit 510 in the optional device 500 and fed to the conveyance path RT7A. The feeding unit 510 is a pickup mechanism that picks up the sheet SH from the feeding tray 502 using a feeding motor 522 as a driving source. The feeding unit 510 includes a feeding roller (pickup roller) 510a, a feeding roller 510b, and a separation roller 510c.

A feeding unit 511 is located on the downstream side of the feeding unit 510, and includes a feeding roller 511a and a driven roller 511b. The feeding roller 511a is a rotor that is rotated by the driving force of the feeding motor 522, and the driven roller 511b is a rotor that rotates following the rotation of the feeding roller 511a.

The sheet SH is clamped in the nip portion between the feeding roller 511a and the driven roller 511b and conveyed by the rotation of the feeding roller 511a and the driven roller 511b.

The sheet SH conveyed by the feeding unit 511 of the optional device 500A passes through the top face side outlet of the optional device 500A and the intermediate point JP3 that is the conveyance path inlet on the bottom surface of the printing apparatus 1A and enters the conveyance path RT6E. The sheet SH is further conveyed to the joining point JP1 through the conveyance path RT6D.

The sheet SH conveyed by the feeding unit 511 of the optional device 500B passes through the top face side outlet of the optional device 500B and the intermediate point JP5 that is the conveyance path inlet on the bottom surface of the optional device 500A and enters the conveyance path RT7B. The sheet SH further passes through the conveyance path RT7B of the optional device 500A and is conveyed to the joining point JP1 through the conveyance path RT6D by the feeding unit 511 of the optional device 500A.

### Printing Unit

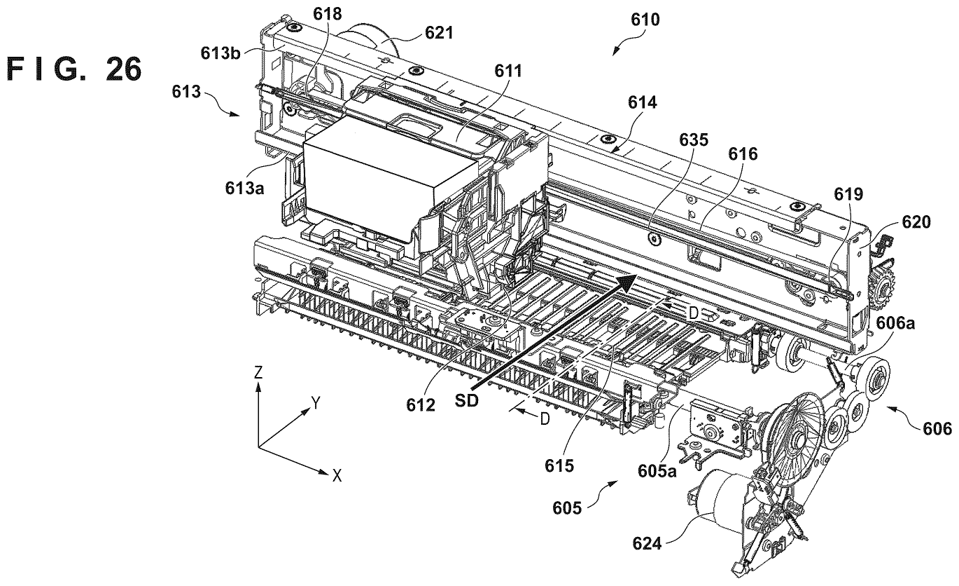

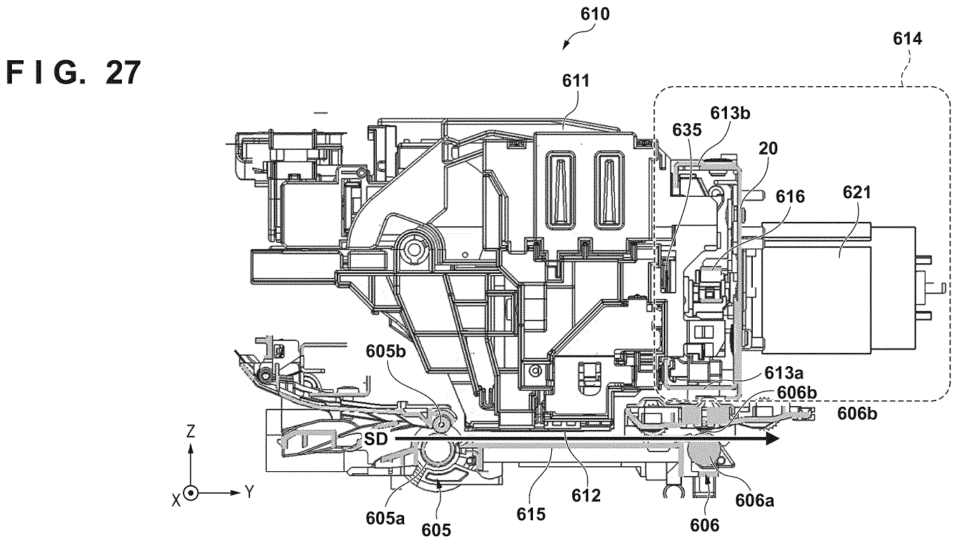

The printing unit 610 according to this embodiment will be described with reference to FIGS. 26 and 27 in addition to FIG. 25. FIG. 26 is a perspective view of the printing unit 610, and FIG. 27 is a sectional view taken along a line D-D in FIG. 25. The printing unit 610 includes the printhead 612, a carriage 611, and a driving unit 614. The printhead 612 discharges liquid ink to the sheet SH, thereby printing an image on the sheet SH. The lower surface of the printhead 612 forms a discharge surface in which a plurality of nozzles for discharging ink are formed.

The ink to be supplied to the printhead 612 is stored in a container 664. In this embodiment, a plurality of containers 664 are stored in a storage portion 667. The ink stored in the container 664 is supplied to the printhead 612 via a tube (not shown) (tube supply method). The opening/closing member 665 is the same member as the opening/closing member 5 described in the first embodiment. The opening/closing member 665 includes the pair of path forming members 666 and forms a conveyance path. When the opening/closing member 665 is detached from the main body 100A, the access path to the storage unit 667 is opened to enable exchange of the container 664. As the configurations of the opening/closing member 665 and the container 664, the configurations exemplified in FIGS. 6A to 13B can also be employed.

The platen 615 is arranged to face the printhead 612 (particularly, the discharge surface) between the conveyance unit 605 and the conveyance unit 606. The sheet SH is conveyed in a direction of an arrow SD (+Y direction) between the printhead 612 and the platen 615, and the printhead 612 prints an image.

The printhead 612 is mounted on the carriage 611. The carriage 611 is reciprocally moved in a direction (in this embodiment, the X-axis direction) crossing the direction SD by the driving unit 614.

The driving unit 614 includes a support member 620 extended in the X-axis direction. The support member 620 is a base member that supports the components of the driving unit 614. The support member 620 is provided with a guide member 613 that engages with the carriage 611 and guides the movement of the carriage 611. In this embodiment, the guide member 613 includes a rail member 613a on the lower side and a rail member 613b on the upper side. The rail members 613a and 613b are apart in the Z-axis direction and are extended in the X-axis direction. The rail members 613a and 613b engage with the carriage 611 and guide the movement of the carriage 611. Note that the guide member 613 may be a member having a shaft form.

The rail member 613a supports the carriage 611 in the height (Z) direction and the front/rear (Y) direction. When the height (Z) of the rail member 613a is adjusted with respect to the support member 620, the height (Z position) of the printhead 612 (particularly, the discharge surface) with respect to the platen 615 can be adjusted. The rail member 613b is located above (+Z direction) the rail member 613a, and regulates the position of the carriage 611 about the X-axis. When the rail member 613b is adjusted with respect to the support member 620 in the front/rear (Y) direction, the tilt of the printhead 612 about the X-axis with respect to the platen 615 can be adjusted.

The driving unit 614 according to this embodiment is a belt transmission mechanism using a carriage motor 621 as a driving source. However, the driving unit 614 may be of a mechanism type other than the belt transmission mechanism. The carriage motor 621 is arranged on the opposite side of the carriage 611 in the front/rear (Y) direction across the support member 620. The driving unit 614 includes a driving pulley 618 and a driven pulley 619, which are apart in the X-axis direction, and an endless belt 616 wound around these pulleys. These are arranged between the rail member 613a and the rail member 613b in the height (Z) direction.

The carriage 611 is fixed to the endless belt 616. When the carriage motor 621 rotates the driving pulley 618, the endless belt 616 travels, and the carriage 611 moves. A cord strip 635 is supported by the support member 620. A sensor (not shown) that detects the slit of the cord strip 635 is provided on the carriage 611, and it is therefore possible to specify the position of the carriage 611 in the X-axis direction or adjust the speed based on the detection result of the sensor.

An electrical contact between the printhead 612 and a board (not shown) is provided on the carriage 611. The board (not shown) may be arranged on the downstream side (+Y direction) of the printhead 612 in the conveyance direction and between the carriage 611 and the support member 620.

An image printing operation will be described next. In the process of reciprocal movement of the carriage 611 in the X-axis direction, ink is discharged from the printhead 612 to the sheet SH, thereby printing an image. This operation is called print scanning. The printing operation is performed by alternately repeating a conveyance operation of intermittently conveying the sheet SH in the direction SD by the conveyance unit 605 and print scanning.

### Front Feeding Mechanism

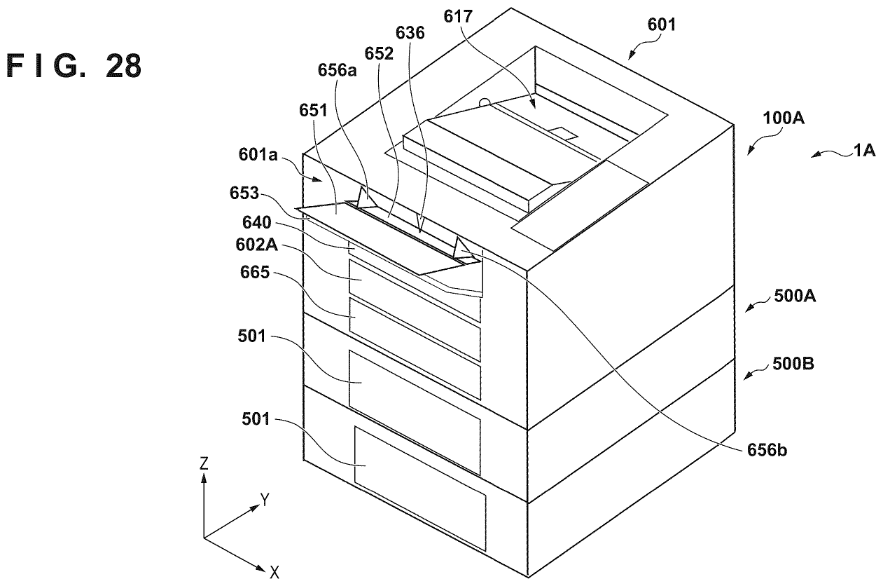

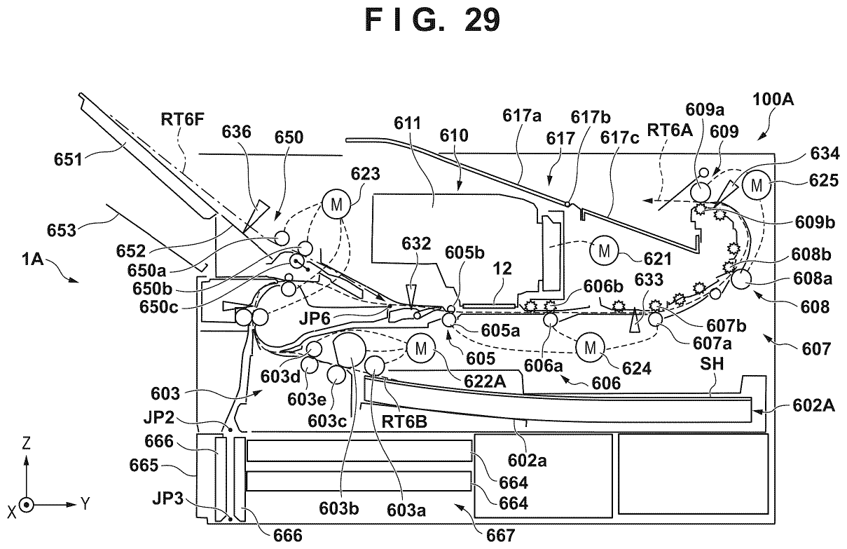

The front feeding mechanism of the printing apparatus 1A will be described with reference to FIGS. 28 and 29. By the front feeding mechanism, the sheet SH can manually be supplied from the front side of the printing apparatus 1A. FIG. 28 is a view showing a state in which the cover 653 and a feeding tray 651 are extracted from the state shown in FIG. 20. FIG. 29 is a schematic view of the internal structure of the printing apparatus 1A, and is a schematic view of a state in which the cover 653 and the feeding tray 651 are extracted.

In this embodiment, in addition to the already described storage cassette 602A, a feeding unit 650 is arranged on the upper side of the storage cassette 602A and the detachable unit 640 in the Z direction (+Z direction) and on the side of the front surface 601a of the printing apparatus 1A. FIG. 20 shows a state in which the stacking tray 651 is closed, and FIG. 28 shows a state in which the stacking tray 651 is opened. In the state in which the stacking tray 651 is closed, a plurality of trays are folded and stored inside. In the state in which the stacking tray 651 is open, the plurality of folded trays are unfolded to such a length that can hold the stacked sheet SH without dropping it.

A feeding tray 652 exists deep in the opened stacking tray 651, and the stacked sheet SH is held by both the stacking tray 651 and the feeding tray 652. There is provided a sensor 636 that detects whether the sheet SH is stacked on the feeding tray 652.

The sensor 636 is a sensor that detects the sheet SH, and is, for example, an optical sensor. The sensor 636 detects the presence/absence of the sheet SH on the feeding tray 652 and can also be formed by, for example, a reflection sensor. In addition, side guides 656a and 656b configured to support the stacked sheet SH in the widthwise direction are attached to the left and right sides of the feeding tray 652. The left and right side guides 656a and 656b are connected by a rack & pinion (not shown). If the user operates one of the side guides, the side guide on the opposite side moves interlocking, and the left and right edges of the sheet SH can be supported.

The arrangement of the feeding unit 650 and the conveyance path RT6F will be described next. The feeding unit 650 includes a feeding roller 650a to be pressed against the sheet SH stacked on the feeding tray 652. A conveyance roller 650b and a separation roller 650c are provided on the downstream side of the feeding roller 650a. The feeding roller 650a and the conveyance roller 650b are driven using the feeding motor 623 as a driving source. The sheet SH set on the feeding tray 652 is picked up by the feeding roller 650a, separated one by one by the nip portion between the conveyance roller 650b and the separation roller 650c, and fed to the conveyance path RT6A. The sheet SH fed from the feeding unit 650 joins the conveyance path RT6A at a joining point JP6, and is conveyed to the conveyance unit 605. After that, the sheet SH is conveyed by the conveyance unit 605, and an image is printed on it by the printhead 612.

### Layout of Components Around Printhead

FIGS. 26 and 27 will be referred to. The sheet SH may cause a jam around the printhead 612. The driving unit 614 is a structure having the support member 620 fixed like a wall member on the X-Z plane. Depending on the arrangement of the driving unit 614, the driving unit 614 of the carriage 611 readily becomes an obstacle when considering the accessibility of the operator to the point of jam.

In this embodiment, the driving unit 614 is arranged on the downstream side (+Y direction) in the conveyance direction (direction SD) with respect to the printhead 612. The space on the upstream side of the printhead 612 is wide, and the accessibility of the operator to the upstream side of the printhead 612 is improved. As the form of a jam, the leading edge portion of the sheet SH is often jammed between the printhead 612 and the platen 615. Hence, since it is easy for the operator to work from the upstream side of the printhead 612, a recovery work can be performed more smoothly.

When viewed in the front/rear direction (Y direction) of the printing apparatus 1A, the conveyance unit 605 is arranged on the front side (−Y direction side) with respect to the printhead 612, and the driving unit 614 is arranged on the rear side (+Y direction side) with respect to the printhead 612. As for the installation place of the printing apparatus 1A, in many cases, the space on the front side of the printing apparatus 1A is wide, and the space on the rear side is narrow due to the presence of a wall or the like. In this embodiment, the space on the front side of the printhead 612 is wide. Hence, if a jam occurs, the operator can easily perform the recovery work from the front side of the printing apparatus 1A.

Also, in this embodiment, the feeding unit 604 is arranged on the front side of the conveyance unit 605. Even if a jam occurs between the feeding unit 604 and the conveyance unit 605, the operator can easily perform the recovery work from the front surface 601a of the printing apparatus 1A.

### Structure Associated With Maintenance

### Maintenance Around Printhead

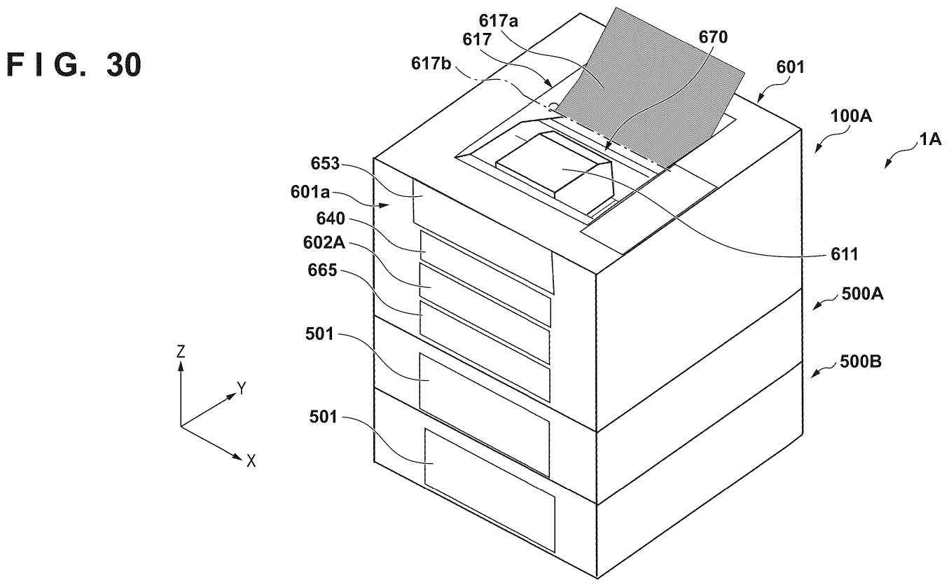

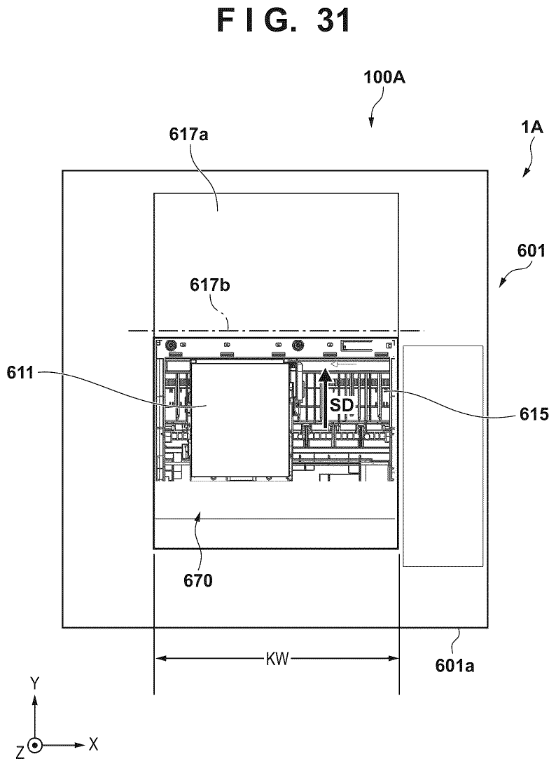

The printing apparatus 1A according to this embodiment has a structure that facilitates maintenance (access) to the printing unit 610. This will be described with reference to FIGS. 23, 24, 30, and 31. FIG. 30 is a view showing the outer appearance of the printing apparatus 1A in which the opening/closing member 617a is in the open state, and FIG. 31 is a plan view of the printing apparatus 1A in which the opening/closing member 617a is in the open state.

Examples of maintenance to the printing unit 610 are the above-described recovery of jam and exchange of the printhead 612.

Of the opening portion 670, a portion on the upstream side (−Y direction side) of the printhead 612 in the conveyance direction (direction SD) is formed to be exposed more than a portion on the downstream side (+Y direction side). The opening/closing member 617a is arranged on the upper side (+Z direction) of the conveyance unit 605. If the opening/closing member 617a is set in the open state, the conveyance unit 605, the carriage 611, the printhead 612, the platen 615, and the like are exposed via the opening portion 670, and the operator can access these. In this embodiment, since the driving unit 614 is arranged on the downstream side (+Y direction side) of the printhead 612 in the conveyance direction, the operator can easily access the conveyance unit 605, the carriage 611, the printhead 612, the platen 615, and the like from the front side of the printing apparatus 1A.

As shown in FIG. 31, defining the width of the opening portion 670 in the X direction as KW, the width KW is larger than the maximum width of the sheets SH supported by the printing apparatus 1A. Hence, if the sheet SH causes a jam, the sheet SH can readily be removed from the opening portion 670.

### 12th Embodiment

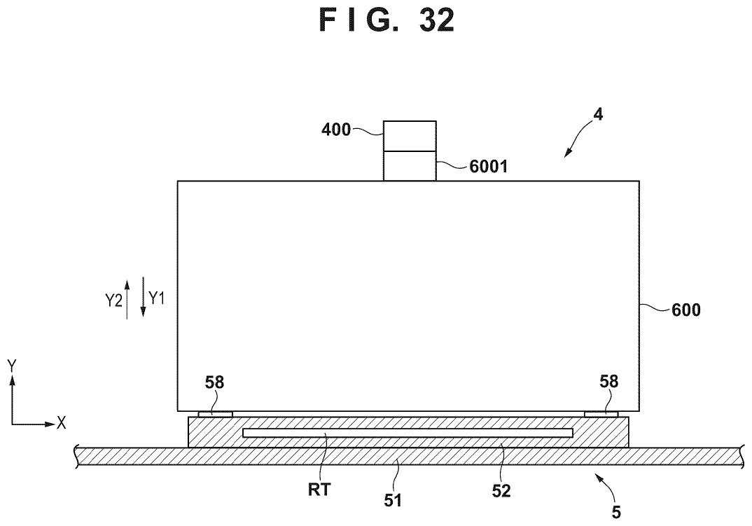

In a storage portion 4, a regulating member that regulates the displacement range of a container 6 in the Y direction may be provided. FIG. 32 is an explanatory view of a regulating member 58. FIG. 32 is, for example, a planar view corresponding to a horizontal sectional view (X-Y plan sectional view) of the storage portion 4 shown in FIG. 1.

A connecting portion 6001 of a container 600 corresponding to the container 6 and a connecting portion 400 to be inserted/removed in the Y direction are provided at the far-side end portion of the storage portion 4 in a direction Y2. By connecting the connecting portion 6001 and the connecting portion 400, for example, formation of an ink channel or electrical connection between the container 600 and a main body 100 of a printing apparatus 1 can be performed.

The regulating member 58 shown in FIG. 32 is a protrusion member provided on a surface of an opening/closing member 5 on the side of the storage portion 4, and protrudes, outside a conveyance path RT in the X direction, from a path forming member 52 to the side of the container 600.

The container 600 may be carelessly displaced to the side of the path forming member 52 other than when the user inserts/removes it to exchange the container 600. Examples of such a case are a case where, for example, when carrying the printing apparatus 1, the user tilts it in a direction to direct the near side of the apparatus downward, and a case where a force is applied to the near side of the apparatus due to rolling or vibration in transportation. In this case, as compared to exchange of the container 600 by the user, the printing apparatus 1 may be in an unusual posture or the displacement speed of the container 600 may be high. As a result, ink in the ink supply path may drop or scatter and contaminate the periphery.

In this embodiment, the gap between the regulating member 58 and the container 600 in the Y direction is designed to be shorter than the distance for separating the connecting portions 601 and 400. Hence, even if the container 600 is carelessly displaced to the side of the path forming member 52, the connecting portions 601 and 400 are not separated, and the above-described contamination by the ink can be prevented. Also, even if the container 600 is displaced in a direction Y1 and a strong impact is applied to the path forming member 52, the regulating members 58 receive the impact force at positions outside the conveyance path RT in the X direction and, therefore, damage to the vicinity of the conveyance path RT can be prevented.

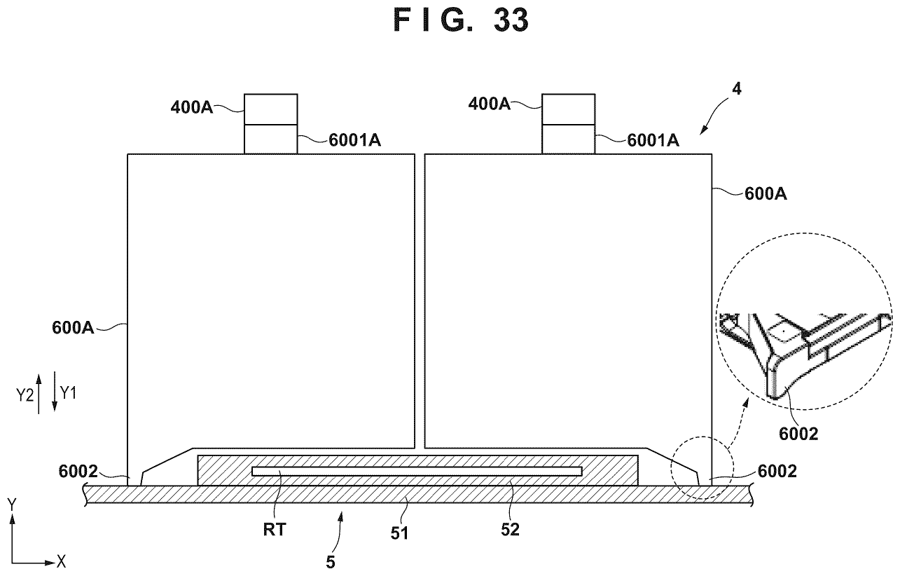

The regulating member may be provided on the container 600. FIG. 33 shows an example. In the form shown in FIG. 33, a plurality of containers 600A are arranged in the X direction in the storage portion 4. Each container 600A includes a connecting portion 6001A and a regulating member 6002. A connecting portion 6001A and a connecting portion 400A to be inserted/removed in the Y direction are provided at the far-side end portion of the storage portion 4 in the direction Y2.

The regulating member 6002 is a protrusion member that protrudes to the side of the opening/closing member 5. The regulating member 6002 faces a panel member 51 at a position outside the path forming member 52 in the X direction. In this configuration, since the regulating member 6002 protrudes to the near side of the printing apparatus 1, the user can easily visually recognize the container 600A stored in the storage portion 4. Note that the regulating member 6002 may be provided with a component corresponding to the above-described operation portion 61 or display portion 62.

FIG. 33 shows an enlarged perspective view of the regulating member 6002. The regulating member 6002 is formed into a box shape and has corners formed by gentle curved surfaces. The container 600A is a portion that the user touches at the time of attachment/detachment, and the user may carelessly drop it. However, since the regulating member 6002 is formed, concentration of the impact force to the regulating member 6002 is relaxed, thereby preventing damage. There is also an effect of relaxing damage when the regulating member 6002 collides against the panel member 51 due to careless displacement of the container 600A from an attached state. It is also possible to prevent the container 600A from colliding against the path forming member 52 and damaging the vicinity of the conveyance path RT.

Next, as options selectable by the user, the printing apparatus 1 may be a product (to be referred to as an A-type product) including a storage cassette 5B or a product (to be referred to as a B-type product) that does not includes the storage cassette 5B. In a case of B-type product, since the path forming member 52 is unnecessary, the opening/closing member 5 can be formed only by the panel member 51. The presence/absence of a regulating member may be changed in accordance with such a plurality of types.

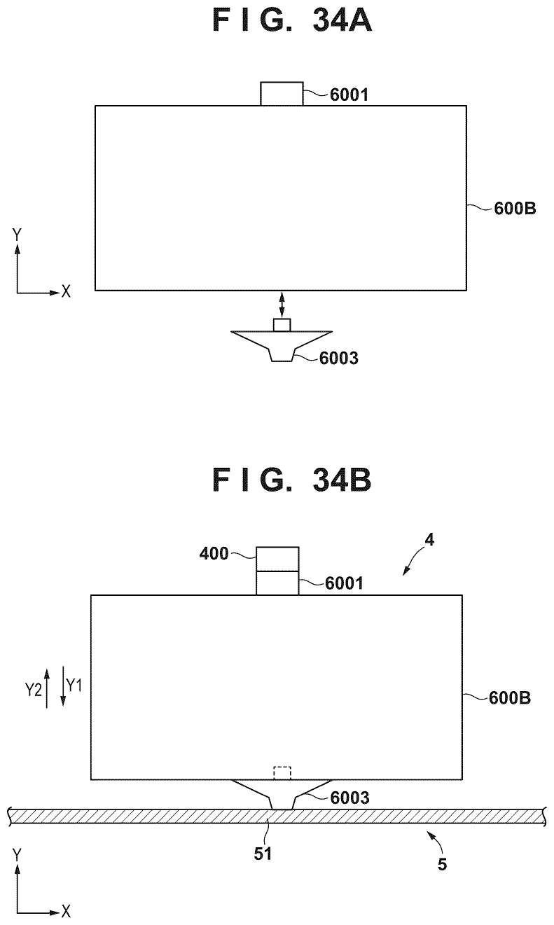

In an example shown in FIG. 34A, a regulating member 6003 is detachably attached to a container 600B. In a case of A-type product, the container 600B is used in a state in which the regulating member 6003 is detached from the container 600B, and the displacement of the container 600B is regulated by the regulating member 58 in the form exemplified in FIG. 32.

In a case of B-type product, the container 600B is used in a state in which the regulating member 6003 is attached to the container 600B, and the displacement of the container 600B is regulated by the regulating member 6003 in the form exemplified in FIG. 34B. The length of the regulating member 6003 in the Y direction is the sum of the lengths of the path forming member 52 and the regulating member 58 in the Y direction. The regulating member 6003 faces the panel member 51 and regulates the displacement of the container 600B in the Y direction.

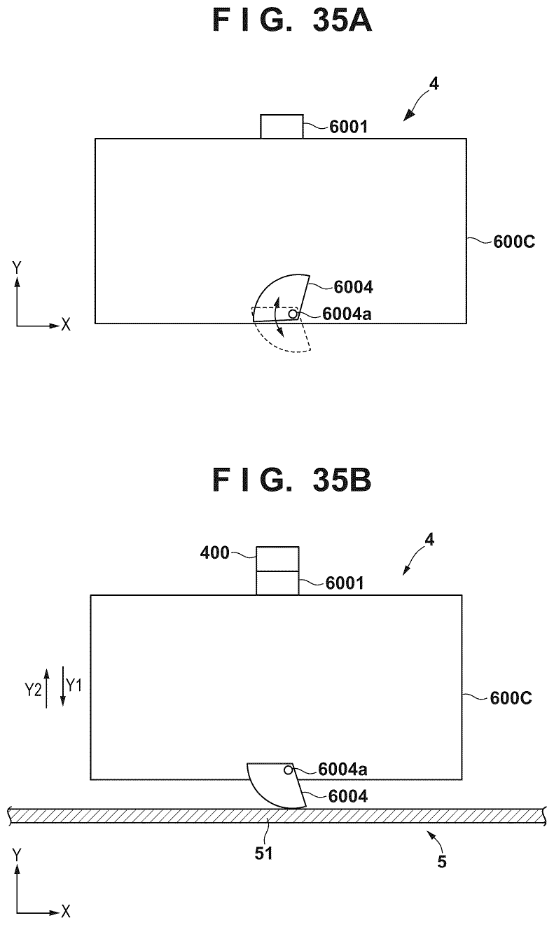

In an example shown in FIG. 35A, a regulating member 6004 is configured to be displaceable with respect to a container 600C. The regulating member 6004 is connected to the container 600C via a shaft 6004a in the Z direction and can rotate between a retreat position indicated by a solid line and a protrusion position indicated by a broken line. At the retreat position, the regulating member 6004 does not protrude from the container 600C. In a case of A-type product, the container 600C is used in a state in which the regulating member 6004 is located at the retreat position, and the displacement of the container 600C is regulated by the regulating member 58 in the form exemplified in FIG. 32.

In a case of B-type product, the container 600C is used in a state in which the regulating member 6004 is located at the protrusion position, and the displacement of the container 600C is regulated by the regulating member 6004 in the form exemplified in FIG. 35B. The protrusion length of the regulating member 6004 in the direction Y1 is the sum of the lengths of the path forming member 52 and the regulating member 58 in the Y direction. The regulating member 6004 faces the panel member 51 and regulates the displacement of the container 600C in the Y direction.

Note that in this embodiment, a bottle-type container has been exemplified as the containers 600 to 600C. However, as described in the fourth embodiment, a bag-type container may be placed on a tray and stored in the storage portion 4. In this case, the regulating member 58 may be arranged to face the tray, and the regulating members 6002 to 6004 may be provided on the tray.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2024-157737, filed Sep. 11, 2024, and No. 2025-100378, filed Jun. 16, 2025, which are hereby incorporated by reference herein in their entirety.

What is claimed is:

1. A printing apparatus comprising:
a storage portion configured to store a container that stores a printing material to be applied to a print medium by a printing unit;
a conveyance unit configured to convey the print medium along a conveyance path; and
an opening/closing member configured to open/close an access path that enables access to the storage portion,
wherein the opening/closing member comprises a path forming member configured to form a partial section of the conveyance path crossing the access path in a state in which the access path is closed.

2. The apparatus according to claim 1, wherein
the access path is a path used by a user to exchange the container.

3. The apparatus according to claim 1, further comprising a stacking portion on which the print medium before printing is stacked,
wherein the storage portion is arranged between the printing unit and the stacking portion, and
the partial section is a section between the stacking portion and the printing unit.

4. The apparatus according to claim 1, further comprising a plurality of stacking portions on which the print medium before printing is stacked,
wherein a first stacking portion among the plurality of stacking portions is arranged between the printing unit and the storage portion,
the storage portion is arranged between the first stacking portion and a second stacking portion among the plurality of stacking portions, and
the partial section is a section between the second stacking portion and the printing unit and is not a section between the first stacking portion and the printing unit.

5. The apparatus according to claim 1, wherein
the path forming member forms a part of a stacking portion on which a printed print medium is stacked.

6. The apparatus according to claim 1, further comprising a plurality of stacking portions on which a printed print medium is stacked,
wherein the path forming member forms a part of one stacking portion among the plurality of stacking portions.

7. The apparatus according to claim 1, wherein
an outer wall of the printing apparatus includes:
an opening portion configured to form the access path; and
a concave portion located around the opening portion.

8. The apparatus according to claim 7, wherein
the concave portion is extended in a lateral direction of the printing apparatus, and
in the lateral direction, the concave portion exists at the same position as at least a part of an operation portion configured to extract the container from the storage portion.

9. The apparatus according to claim 7, wherein
the concave portion is extended in a lateral direction of the printing apparatus, and
in the lateral direction, the concave portion exists at the same position as at least a part of a display portion showing information about the printing material stored in the container.

10. The apparatus according to claim 8, wherein
a plurality of containers are stored in the storage portion,
the operation portion is provided for each container, and
in the lateral direction, the concave portion exists at the same position as at least a part of each operation portion.

11. The apparatus according to claim 9, wherein
a plurality of containers are stored in the storage portion,
the display portion is provided for each container, and
in the lateral direction, the concave portion exists at the same position as at least a part of each display portion.

12. The apparatus according to claim 7, wherein
the concave portion is extended in a lateral direction of the printing apparatus,
the storage portion includes an inlet that is exposed in a state in which the access path is opened by the opening/closing member, and
in the lateral direction, the concave portion is located at a center portion of the inlet in the lateral direction.

13. The apparatus according to claim 7, wherein
a plurality of containers are stored in the storage portion,
the concave portion is extended in a lateral direction of the printing apparatus,
the storage portion includes an inlet that is exposed when the access path is opened by the opening/closing member,
in the lateral direction, the concave portion is located at a center portion of the inlet in the lateral direction, and
in the lateral direction, a display portion provided for each container and showing information about the printing material stored in a corresponding container is located at the center portion of the inlet in the lateral direction.

14. The apparatus according to claim 8, wherein
the operation portion is provided on the container.

15. The apparatus according to claim 8, wherein
the container is stored in the storage portion with being placed on a tray, and
the operation portion is provided on the tray.

16. The apparatus according to claim 9, wherein
the display portion is provided on the container.

17. The apparatus according to claim 9, wherein
the container is stored in the storage portion with being placed on a tray, and
the display portion is provided on the tray.

18. The apparatus according to claim 1, wherein
an outer wall of the printing apparatus includes an opening portion configured to form the access path, and
the opening/closing member comprises a panel member configured to close the opening portion when the access path is closed.

19. The apparatus according to claim 1, wherein
an outer wall of the printing apparatus includes an opening portion configured to form the access path,
a panel member configured to open/close the opening portion is provided on the outer wall of the printing apparatus, and
when the access path is closed, the opening/closing member is located inside the panel member in a closed state.

20. The apparatus according to claim 4, further comprising a selecting unit configured to select, among the plurality of stacking portions, a stacking portion to stack the print medium to be used for printing,
wherein when the access path is opened by the opening/closing member, the selecting unit selects a stacking portion other than the second stacking portion.

21. The apparatus according to claim 6, further comprising a selecting unit configured to select, among the plurality of stacking portions, a stacking portion to which the printed print medium is conveyed,
wherein when the access path is opened by the opening/closing member, the selecting unit selects a stacking portion other than the one stacking portion.

22. The apparatus according to claim 1, wherein
the opening/closing member is rotatably provided.

23. The apparatus according to claim 1, wherein
the opening/closing member is provided to be detachable from a main body of the printing apparatus.

24. The apparatus according to claim 1, wherein
the access path is opened to a front surface of the printing apparatus.

25. The apparatus according to claim 1, wherein
the printing material is ink, and
the printing unit discharges the ink to the print medium.

26. The apparatus according to claim 2, further comprising a regulating member configured to regulate displacement of the container in the storage portion in an insertion/removal direction of the container with respect to the storage portion.

27. The apparatus according to claim 26, wherein
the regulating member is a protrusion member formed on a surface of the opening/closing member on a side of the storage portion.

28. The apparatus according to claim 26, wherein
the regulating member is a protrusion member formed at an end portion of the container on a side of the opening/closing member.

29. The apparatus according to claim 28, wherein
an outer wall of the printing apparatus includes an opening portion configured to form the access path,
the opening/closing member comprises a panel member configured to close the opening portion when the access path is closed, and
the protrusion member is arranged at a position not facing the path forming member but facing the panel member.

30. The apparatus according to claim 28, wherein
a plurality of containers are stored in the storage portion, and
the protrusion member is formed on each of the plurality of containers.
